(19) United States
(12) Patent Application Publication
(10) Pub. No.: US 2024/0193909 A1
(43) Pub. Date: Jun. 13, 2024

(54) DETERMINE PATTERNS ASSOCIATED WITH OBJECTS IN CAPTURED IMAGES

(71) Applicant: Meta Platforms Technologies, LLC, Menlo Park, CA (US)

(72) Inventors: Saransh SOLANKI, Seattle, WA (US); Gregg WYGONIK, Woodinville, WA (US); Yu-Jen LIN, Redmond, WA (US); Nicci YIN, Seattle, WA (US); James TICHENOR, Seattle, WA (US)

(73) Assignee: Meta Platforms Technologies, LLC, Menlo Park, CA (US)

(21) Appl. No.: 18/535,946

(22) Filed: Dec. 11, 2023

Related U.S. Application Data
(60) Provisional application No. 63/436,347, filed on Dec. 30, 2022.
(60) Provisional application No. 63/435,731, filed on Dec. 28, 2022.
(60) Provisional application No. 63/431,964, filed on Dec. 12, 2022.

(51) Int. Cl. G06V 10/70; G02B 27/01; G06V 10/44

(52) U.S. Cl. CPC G06V 10/70; G02B 27/0172; G06V 10/44; G06V 2201/07

(57) ABSTRACT

According to examples, an apparatus may include a memory on which is stored machine-readable instructions that when executed by a processor, cause the processor to identify an object of interest in at least one first image of an environment captured by a wearable eyewear device during a first time period and identify the object of interest in at least one second image of the environment captured by a wearable eyewear device during a second time period. The processor may also determine a pattern associated with the object of interest based on the at least one first image of the identified object of interest and the at least one second image. In one regard, the processor may determine patterns associated with the object of interest, which may be hidden to or otherwise undetected by a user of the wearable eyewear device.

### PRIORITY

This patent application claims priority to U.S. Provisional Patent Application No. 63/435,731, entitled “Systems and Methods for Manufacturing and Producing Optical Devices Having Polymeric Components,” filed on Dec. 28, 2022, and U.S. Provisional Patent Application No. 63/436,347, entitled “Localized Noise Reduction for Audio Transmissions,” filed on Dec. 30, 2022, and U.S. Provisional Patent Application No. 63/431,964, entitled “Determine Patterns Associated with Objects in Captured Images,” filed on Dec. 12, 2022, the disclosures of which are hereby incorporated by reference in their entireties.

### TECHNICAL FIELD

This patent application relates generally to image processing and pattern recognition for a wearable eyewear device. Particularly, this patent application relates to the determination of patterns based on changes in features of objects over time as determined from images captured of the objects over time. This patent application also relates generally to a manufacturing and production of materials, and more specifically, to systems and methods for manufacturing and producing of optical devices having polymeric components. This patent application further relates generally to data transmission and content playback, and more specifically, to systems and methods for localized noise reduction for audio transmissions.

### BACKGROUND

With recent advances in technology, prevalence and proliferation of content creation and delivery have increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

Providing VR, AR, or MR content to users through a wearable eyewear device, such as a wearable eyewear, a wearable headset, a head-mountable device, and smartglasses often relies on localizing a position of the wearable eyewear device in an environment. The localizing of the wearable eyewear device position may include the determination of a three dimensional mapping of the user's surroundings within the environment. In some instances, the user's surroundings may be represented in a virtual environment of the user's surroundings may be overlaid with additional content. Providing VR, AR, or MR content to users may also include tracking users' eyes, such as by tracking a user's gaze, which may include detecting an orientation of an eye in three-dimensional (3D) space.

In some examples, a display device may include a physical medium through which light may be projected. One such example may be a lens on an augmented reality (AR) headset. In some instances, the physical medium may be comprised of transparent glass.

In other instances, a physical medium may be comprised of one or more polymers. In some examples, these polymers may exhibit (i.e., offer) a large variety of material properties.

In some examples, a polymer component (e.g., a geometric waveguide) may be produced via use of an injection molding process. In particular, in some examples, a first injection-molded layer may be layered on top of a second injection-molded layer. In these examples, a bonding layer may attach (e.g., glue) the first layer to the second layer. However, since the material properties of the bonding layer may be different that the material properties of the first and the second layer, this may result in one or more non-uniformities that may impact performance.

Various types of digital communication methods between a plurality of parties have gained significant popularity in recent years. Examples include video and audio conferencing. In some instances, video and audio conferencing may be a convenient alternative to an in-person meeting. For example, since an advent of a global pandemic, many workers (worldwide) have been able to maintain if not increase efficiency through use of these technologies while working remotely.

However, these technologies may also come with their own disadvantages. For example, unwanted sounds from a speaker (e.g., sender) side of an audio or video conference may, in some instances, negatively impact a listener's (e.g., receiver) side experience of the conference.

A “noise cancelling” technology (e.g., a software algorithm) may be utilized to minimize or even mute an unwanted noise from captured audio of the conference. Specifically, the noise cancelling technology may be configured to, among other things, analyze portion of the captured audio to determine a speaker's voice and other sounds, and may adjust aspects of the captured audio to emphasize the speaker's voice and/or minimize or mute other (captured) sounds that may detrimentally affect a listener's experience.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a diagram of an apparatus for determining a pattern associated with an object of interest identified in a plurality of images captured by a wearable eyewear device, according to an example.

FIGS. 2A and 2B, respectively, illustrate diagrams of a first image and a second image including an object of interest, according to an example.

FIG. 3 illustrates a diagram of the apparatus depicted in FIG. 1, according to an example.

FIG. 4 illustrates a perspective view of a wearable eyewear device, such as a near-eye display device, and particularly, a head-mountable display (HMD) device, according to an example.

FIG. 5 illustrates a perspective view of a wearable eyewear device, such as a near-eye display, in the form of a pair of smartglasses, glasses, or other similar eyewear, according to an example.

FIG. 6 illustrates a flow diagram of a method for determining a pattern associated with an object of interest based on images of the object of interest, according to an example.

FIG. 7 illustrates a block diagram of a computer-readable medium that has stored thereon computer-readable instructions for determining a pattern associated with an object of interest based on images of the object of interest captured by a wearable eyewear device, according to an example.

FIG. 8 illustrates a block diagram of an artificial reality system environment including a near-eye display, according to an example.

FIG. 9 illustrates a perspective view of a near-eye display in the form of a head-mounted display (HMD) device, according to an example.

FIG. 10 is a perspective view of a near-eye display in the form of a pair of glasses, according to an example.

FIG. 11 illustrates a schematic diagram of an optical system in a near-eye display system, according to an example.

FIGS. 12A-12C illustrate various aspects of a system environment, including a system, that may be implemented for manufacturing and producing of optical devices having polymeric components, according to an example.

FIG. 13 illustrates a flow diagram of a method that may be implemented for manufacturing and producing of optical devices having polymeric components, according to an example.

FIGS. 14A-14B illustrates a block diagram of a system environment, including a system, to provide for localized noise reduction for audio transmissions, according to an example.

FIG. 14C illustrates a system environment including one or more transmitting devices transmitting an audio signal to a receiving device, according to an example.

FIG. 14D illustrates a system environment including one or more transmitting devices transmitting an audio signals to a receiving device with noise reduction features, according to an example.

FIG. 14E illustrates one or more interface elements in a user interface to provide localized noise reduction features, according to an example.

FIG. 15 illustrates a block diagram of a computer system for localized noise reduction for audio transmissions, according to an example.

FIG. 16 illustrates a method for localized noise reduction for audio transmissions, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

People often go through their daily lives without paying much attention to various patterns that may be occurring around them. This may occur because people have relatively limited sensory functions and are unable to detect the various patterns.

Disclosed herein are an apparatus that may determine the patterns from images captured in a wearble eyewear device user's environment. Particularly, for instance, a wearable eyewear device may include an imaging component that may capture images of a user's environment as the user goes about their day. A processor of the apparatus may identify an object of interest in images captured over time and may also determine changes in a feature of the object of interest over time. In addition, the processor may determine a pattern associated with the object of interest based on an analysis of the images captured over time by the wearable eyewear device. In some examples, the processor may determine an action corresponding to the determined pattern and may output and/or execute the determined action.

Through implementation of the features of the present disclosure, the processor may identify patterns associated with an object of interest, which may otherwise be hidden from a user of a wearable eyewear device. The processor may also inform a user of the pattern, an action for the user to take responsive to the pattern, take an action responsive to the pattern, and/or the like. In some examples, the processor may determine from the pattern that an action may be taken to reduce energy consumption, increase security, improve operations of machines, plants, or animals, and/or the like. For instance, the processor may determine that the pattern denotes that a machine is active when unnecessary, and may reduce the operation of the machine.

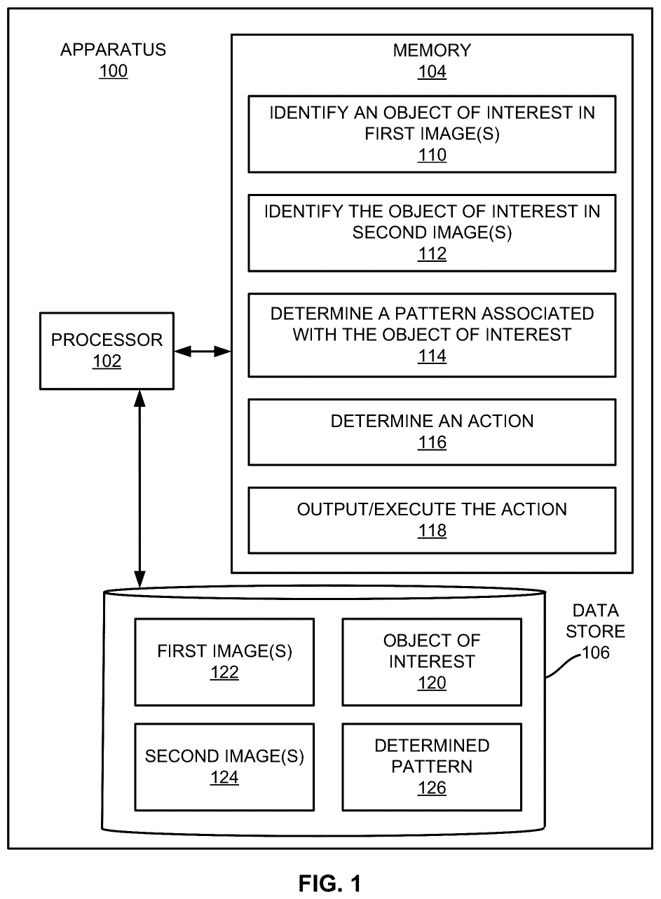

FIG. 1 illustrates a diagram of an apparatus 100 for determining a pattern associated with an object of interest identified in a plurality of images captured by a wearable eyewear device, according to an example. The wearable eyewear device may be a wearable headset, smart glasses, a head-mountable device, eyeglasses, or the like, that includes an imaging component (not shown in FIG. 1) to capture images of an environment around the wearable eyewear device. In some examples, the apparatus 100 may be the wearable eyewear device that captured the images. In other examples, the apparatus 100 may be a computing device, such as a laptop computer, a desktop computer, a tablet computer, a smartphone, a server, or the like. In these examples, the apparatus 100 may receive data corresponding to the images captured by the wearable eyewear device. For instance, the apparatus 100 may receive the data from the wearable eyewear device via a wireless communication protocol connection, a wired connection, via a network (such as the Internet), etc.

As shown in FIG. 1, the apparatus 100 may include a processor 102, a memory 104, and a data store 106. The apparatus 100 may also include additional components that are not described in detail herein. The processor 102 may control operations of the apparatus 100 and may be a semiconductor-based microprocessor, a central processing unit (CPU), an application specific integrated circuit (ASIC), a field-programmable gate array (FPGA), and/or other hardware device. References made herein to the apparatus 100 performing various operations should equivalently be construed as meaning that the processor 102 of the apparatus 100 may perform those various operations.

The memory 104 may have stored thereon instructions that the processor 102 may access and/or may execute. In addition, the processor 102 may store and access various information in the data store 106 as discussed herein. The memory 104 and the data store 106 may each be a computer-readable medium, such as a Random Access memory (RAM), an Electrically Erasable Programmable Read-Only Memory (EEPROM), a storage device, or the like. The memory 104 and the data store 106 may each be a non-transitory computer-readable storage medium, where the term “non-transitory” does not encompass transitory propagating signals.

Although the apparatus 100 is depicted as having a single processor 102, it should be understood that the apparatus 100 may include additional processors and/or cores without departing from a scope of the apparatus 100. In this regard, references to a single processor 102 as well as to a single memory 104 may be understood to additionally or alternatively pertain to multiple processors 102 and/or multiple memories 104. In addition, or alternatively, the processor 102 and the memory 104 may be integrated into a single component, e.g., an integrated circuit on which both the processor 102 and the memory 104 may be provided. In addition, or alternatively, the operations described herein as being performed by the processor 102 may be distributed across multiple processors 102.

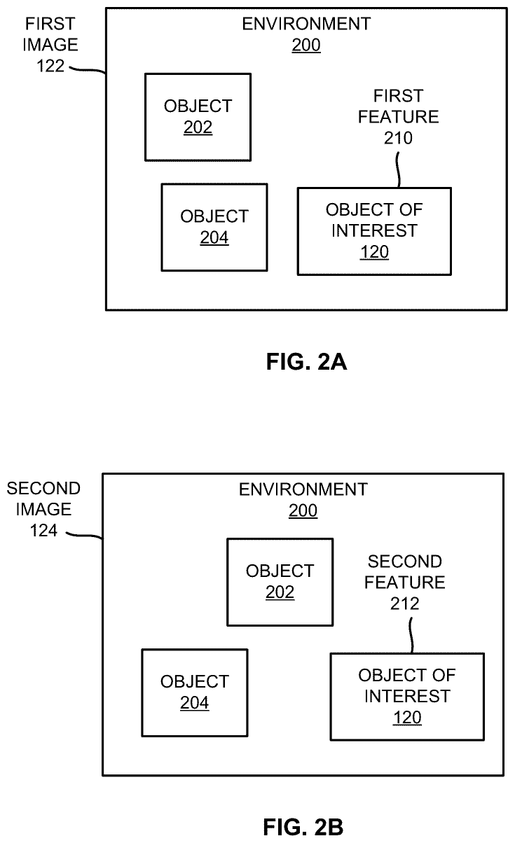

As also shown in FIG. 1, the memory 104 may have stored thereon machine-readable instructions 110-118 that the processor 102 may execute. The processor 102 may execute the instructions 110 to identify an object of interest 120 in at least one first image 122 of an environment 200 (FIG. 2A) captured by a wearable eyewear device during a first time period. The first image(s) 122, which may be a still image or a video captured by the wearable eyewear device, for instance, as a user of the wearable eyewear device moves around the environment 200. In some examples, the wearable eyewear device may be programmed or otherwise controlled to capture the first images 122 during a first time period when the wearable eyewear device is located within the environment 200.

The processor 102 may automatically identify the object of interest 120 in the first image(s) 122. Particularly, for instance, the processor 102 may execute an image recognition program on the first image(s) 122 to identify the object of interest 120. In some examples, and as shown in FIG. 2A, the first image(s) 122 may include other objects 202, 204 that the processor 102 may have identified. The processor 102 may identify the objects included in the first image(s) 122 through execution of the image recognition program. In addition, the processor 102 may identify the object of interest 120 as one of the identified objects.

In some examples, the processor 102 may automatically identify an object as an object of interest 120. In these examples, for instance, the processor 102 may determine that the same object appears in multiple first images 122 and may track that object as an object of interest 120. As another example, the processor 102 may be instructed to identify particular types of objects as the object of interest 120. In some examples, the processor 102 may be instructed to identify a particular object as the object of interest 120. In some examples, the processor 102 may identify multiple ones of the objects appearing in the first image(s) 122 and may identify multiple objects as objects of interest 120.

In some examples, the object of interest 120 may be any of a number of various types of objects that may have features or states that may vary over time. For instance, the object of interest 120 may be an object that may be depleted, used, consumed, or the like, over time. By way of non-limiting example, the object of interest 120 may be a consumable item, such as a carton of eggs, a bag of rice, a milk carton, a box of cereal, or the like. As another example, the object of interest 120 may be an object that a user of a wearable eyewear device may see on a regular basis, such as daily, weekly, monthly, etc. By way of non-limiting example, the object of interest 120 may be an air vent, a light source, an air conditioning device, a television monitor, furniture, walls, a thermostat, or the like, in the wearable eyewear device user's dwelling, office, or the like. As other examples, the object of interest 120 may be an object corresponding to a routine, e.g., a coffee cup or a coffee machine that is used often, an object corresponding to an activity such as walking (such as a tree or a landmark), eating, running, reading (such as a book), etc., or an object corresponding to other actions. As yet further examples, the object of interest 120 may be other living beings such as pets and people (from whom consent has been given).

The processor 102 may execute the instructions 112 to identify the object of interest 120 in at least one second image 124 of the environment 200 (FIG. 2B) captured by a wearable eyewear device during a second time period. The at least one second image 124 may be captured by the same wearable eyewear device that captured the at least one first image 122 or a wearable eyewear device that differs from that wearable eyewear device. The second time period may be a time period that is after the first time period. For instance, the second time period may be an hour or more, e.g., another day, another week, etc., after the first time period. In any regard, the processor 102 may identify the object of interest 120 in the second image(s) 124 in any of the manners discussed above with respect to the identification of the objection of interest 120 in the first image(s) 122.

As shown in FIG. 2A, the object of interest 120 may have a first feature 210 during a first time period, e.g., during the time when the first image 122 was captured. The first feature 210 may be a certain aspect of the object of interest 120 that the processor 102 may determine from the first image 122. For instance, the first feature 210 may be whether the object of interest 120 is active or not, a level of the object of interest 120, a direction in which the object of interest 120 is facing, a temperature of the object of interest 120, a location of the object of interest 120, and/or the like.

In FIG. 2B, the object of interest 120 is depicted as having a second feature 212 during a second time period, e.g., during the time when the second image 124 was captured. The second feature 212 may be related to the first feature 210 in that the second feature 212 may be equivalent to the first feature 210 at the same or different state. For instance, the second feature 212 may be another level of the object of interest 120, a change in the temperature of the object of interest 120, and/or the like.

The processor 102 may execute the instructions 114 to determine a pattern 126 associated with the object of interest 120 based on images of the identified object of interest 120 during the first time period and the second time period. In some examples, the processor 102 may apply an artificial intelligence (AI) algorithm on the at least one first image and the at least one second image of the object of interest 120 to determine the pattern. The processor 102 (or another computing device) may apply a machine learning algorithm on historical data to create the AI algorithm. For instance, the machine learning algorithm may take, as inputs, various features of the object of interest 120 and may determine predicted outputs from the inputs. Non-limiting examples of suitable machine learning algorithms may include linear regression, logistic regression, Naive Bayes algorithm, random forest algorithm, K-means, KNN algorithm, etc.

In some examples, the processor 102 may also use other sensory information to determine the pattern 126. For instance, the processor 102 may use information such as time and weather information obtained, for instance, from the Internet, a thermostat reading or smart light switch statuses from an IoT system, and/or the like. In these examples, the processor 102 may use the other sensory information with the other information to determine the pattern 126.

According to examples in which the object of interest 120 is a consumable object, the processor 102 may determine the pattern 126 to be a rate at which the object of interest 120 is being consumed over time. In other words, the processor 102 may determine that the pattern 126 associated with the object of interest 120 to be a rate at which a feature 210, 212 of the object of interest 120 has changed over time based on the images of the identified object of interest 120 during the first time period and the second time period. Likewise, in examples in which the object of interest 120 includes consumable items, the processor 102 may determine the pattern 126 to be a rate at which the consumable items are consumed over time. In other examples in which the object of interest 120 is a machine, for instance, an air conditioning unit, a television monitor, a computing device, or the like, the processor 102 may determine the pattern 126 to be times during which the machine is active or inactive. Aa a further example in which the object of interest 120 is a plant, the processor 102 may determine the pattern 126 to be an identification of an approximate direction of airflow from a vent onto the plant. As a yet further example in which the object of interest 120 is a room or a space that includes a furniture arrangement, a wall color, etc., the processor 102 may determine the pattern 126 to be a change to an order in the way people usually perform certain routines, which may include user-defined routines or a pattern 126 that the processor 102 may recognize over time. By way of particular example, if a user works from home and leaves their house, the processor 102 may learn that the user is going outside and may leave conditions inside the house as-is, e.g., by not turning off the lights, by not changing a temperature setting, etc. However, if it is past a certain time and the user has left the house, the processor 102 may make changes to the conditions inside or around the house, such as turning off lights, changing the environmental conditions, turning on exterior lights, etc.

The processor 102 may execute the instructions 116 to determine an action corresponding to the determined pattern 126. As discussed herein, the action corresponding to the determined pattern 126 may depend upon the determined pattern 126 and the object of interest 120. For instance, the action may be the generation of an instruction or message to inform a user of the determined pattern 126, the generation of an instruction to automatically perform an action based on the determined pattern 126, the generation of an image to be displayed on a display of a wearable eyewear device based on the determined pattern 126, etc.

By way of non-limiting example, the action may be the generation of a message that the object of interest 120 is likely to be depleted relatively soon as determined from the pattern 126. As another example, the action may be an instruction to automatically order the object of interest 120 based on the determined pattern 126 indicating that the object of interest 120 is likely to be depleted relatively soon. As a further example, the action may be the generation of a message that a user should move a plant away from an air vent based on the determined pattern indicating that the plant is located within the airflow of a vent. As a yet further example, the action may be the generation of a message that a user should change the temperature setting of a thermostat during certain times based on the determined pattern indicating that a room has more than a certain number of people.

The processor 102 may execute the instructions 118 to output and/or execute the determined action. By way of example, the processor 102 may output a generated message to the wearable eyewear device or another one of a user's computing devices. As another example, the processor 102 may execute a generated instruction such as to automatically change a thermostat setting, order an object of interest 120, cause a message to be displayed on a wearable eyewear device, and/or the like. Particularly, for instance, the processor 102 may generate an item, e.g., message, instruction, image, or the like, to be displayed from the determined action and may cause the item to be displayed on the wearable eyewear device. The item may be displayed as part of an AR display on the wearable eyewear device.

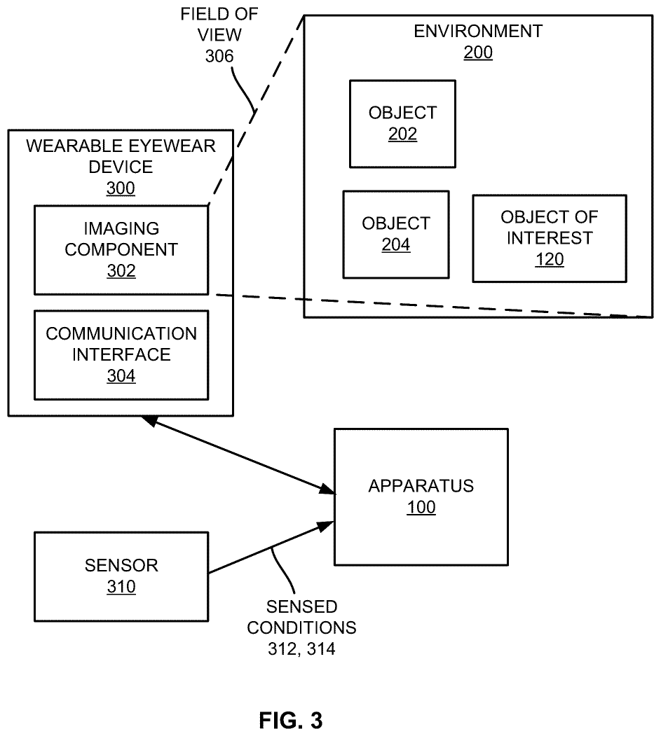

Turning now to FIG. 3, there is illustrated a diagram of the apparatus 100 depicted in FIG. 1, according to an example. As shown in FIG. 3, the apparatus 100 may be separate from a wearable eyewear device 300 that may capture the images 122, 124 of the environment 200. In other examples, however, the wearable eyewear device 300 and the apparatus 100 may be the same component. The wearable eyewear device 300 may include an imaging component 302 that may capture at least one image of the environment 200 in which the wearable eyewear device 300 may be located. The field of view 306 of the imaging component 302 is denoted by the dashed lines.

The imaging component 302 may be or may include an imaging device that captures the at least one image 122, 124. For instance, the imaging component 302 may include a charge-coupled device (CCD), a complementary metal-oxide-semiconductor (CMOS) device, or the like. The imaging device may be, e.g., a detector array of CCD or CMOS pixels, a camera or a video camera, another device configured to capture light, capture light in a visible band (e.g., ˜380 nm-700 nm), capture light in the infrared band (e.g., 780 nm to 2500 nm), or the like.

The wearable eyewear device 300 may also include a communication interface 304 through which the wearable eyewear device 300 may communicate with the apparatus 100. The communication interface 304 may include hardware and/or software that may enable communications with the apparatus 100. For instance, the communication interface 304 may include a Bluetooth™ antenna, a WiFi antenna, an Ethernet port, and/or the like. In any of these examples, the wearable eyewear device 300 may communicate the captured images 122, 124 of the environment 200 including the object of interest 120 to the apparatus 100 through the communication interface 304. The wearable eyewear device 300 may also receive data from the apparatus 100, in which the data may include data corresponding to images to be displayed on the wearable eyewear device 300.

In some examples, the apparatus 100 may receive data from a sensor 310 that may be external to the wearable eyewear device 300 and the apparatus 100. The sensor 310 may be positioned to detect a condition within the environment 200 in which the wearable eyewear device 300 may capture the images 122, 124 that include the object of interest 120. The sensor 310 may detect an environmental condition within the environment 200, such as temperature, humidity, airflow direction, airflow velocity, etc. The sensor 310 may additionally or alternatively detect movement of objects, people, animals, etc. As other examples, the sensor 310 may detect a device state (e.g., on/off state), natural light, gas, smoke, movement, steps, heart rate, biometrics, audio/noise, images (e.g., from a camera), etc.

In some examples, the processor 102 may access at least one first sensed condition 312 in the environment 200 detected by the sensor 310 during the first time period. In addition, the processor 102 may access at least one second sensed condition 314 in the environment 200 detected by the sensor 310 during the second time period. The processor 102 may determine the pattern 126 associated with the object of interest 120 based also on the at least one first sensed condition 312 and the at least one second sensed condition 314. That is, for instance, the processor 102 may apply an AI algorithm on images of the object of interest 120, the first sensed condition(s) 312, and the second sensed condition(s) 314 to determine the pattern. By way of particular example, an audio sensor 310 may hear environmental sounds inside a home, such as the running of water from a tap and may feed this information to the processor 102. The processor 102 may construct a preferable behavior (such as the duration of time that the tap should be running) through reinforcement learning over time. When the processor 102 determines that the tap has been running longer than the duration corresponding to the preferable behavior, the processor 102 may determine that there may be a water leak or that someone forgot to turn off the tap. As another example, using data received from an ambient lighting sensor and an air quality sensor, the processor 102 may infer and predict when the air quality and lighting in an office is below a preferable range that could lead to fatigue and lethargy based on reinforcement learning using the collected information.

According to examples, the processor 102 may access additional images of the environment 200 captured by the wearable eyewear device 300 during additional time periods. In these examples, the processor 102 may identify the object of interest 120 in the additional images and may update the pattern 126 associated with the object of interest 120 based on images of the identified object of interest 120 in the additional images. Particularly, for instance, the processor 102 may update the pattern 126 based on an analysis of the features 210, 212 of the object of interest 120 as the features 210, 212 may have changed over time. The processor 102 may also access additional conditions sensed by the sensor 310 and may include the additional sensed conditions in updating the pattern 126 associated with the object of interest 120.

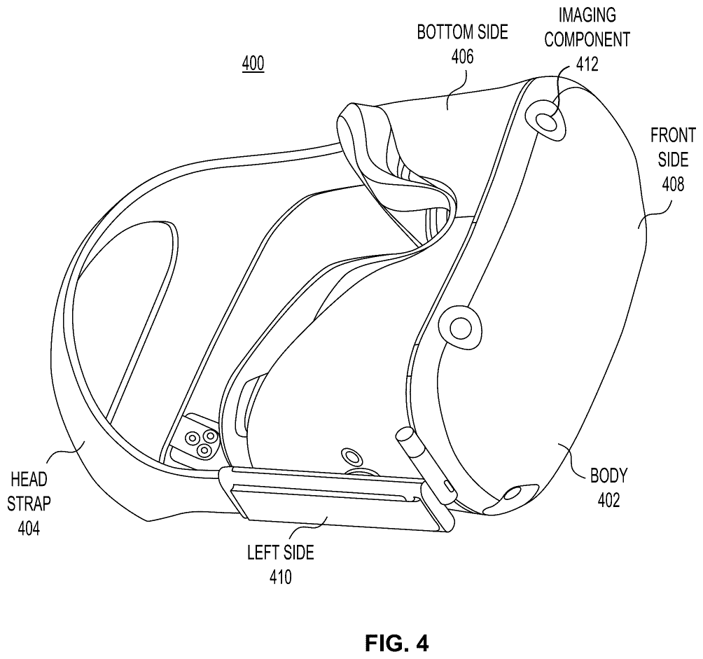

FIG. 4 illustrates a perspective view of a wearable eyewear device 400, such as a near-eye display device, and particularly, a head-mountable display (HMD) device, according to an example. The wearable eyewear device 400 may be equivalent to the wearable eyewear device 300 depicted in FIG. 3. In some examples, the HMD device 400 may be part of a virtual reality (VR) system, an augmented reality (AR) system, a mixed reality (MR) system, another system that uses displays or wearables, or any combination thereof. In some examples, the HMD device 400 may include a body 402 and a head strap 404. FIG. 4 shows a bottom side 406, a front side 408, and a left side 410 of the body 402 in the perspective view. In some examples, the head strap 404 may have an adjustable or extendible length. In particular, in some examples, there may be a sufficient space between the body 402 and the head strap 404 of the HMD device 400 to allow a user to mount the HMD device 400 onto the user's head. In some examples, the HMD device 400 may include additional, fewer, and/or different components. For instance, the HMD device 400 may include the components of the apparatus 100 as discussed herein.

In some examples, the HMD device 400 may present, to a user, media or other digital content including virtual and/or augmented views of a physical, real-world environment with computer-generated elements. In this regard, the HMD device 400 may include an imaging component 412 that may capture images of an environment 200 around the HMD device 400. Examples of the media or digital content presented by the HMD device 400 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 4) enclosed in the body 402 of the HMD device 400.

In some examples, the HMD device 400 may include various sensors (not shown), such as depth sensors, motion sensors, position sensors, and/or eye tracking sensors. Some of these sensors may use any number of structured or unstructured light patterns for sensing purposes as discussed herein. In some examples, the HMD device 400 may include a virtual reality engine (not shown), that may execute applications within the HMD device 400 and receive depth information, position information, acceleration information, velocity information, predicted future positions, or any combination thereof of the HMD device 400 from the various sensors.

In some examples, the information received by the virtual reality engine may be used for producing a signal (e.g., display instructions) to the one or more display electronics. In some examples, the HMD device 400 may include locators (not shown), which may be located in fixed positions on the body 402 of the HMD device 400 relative to one another and relative to a reference point. Each of the locators may emit light that is detectable by an external camera. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

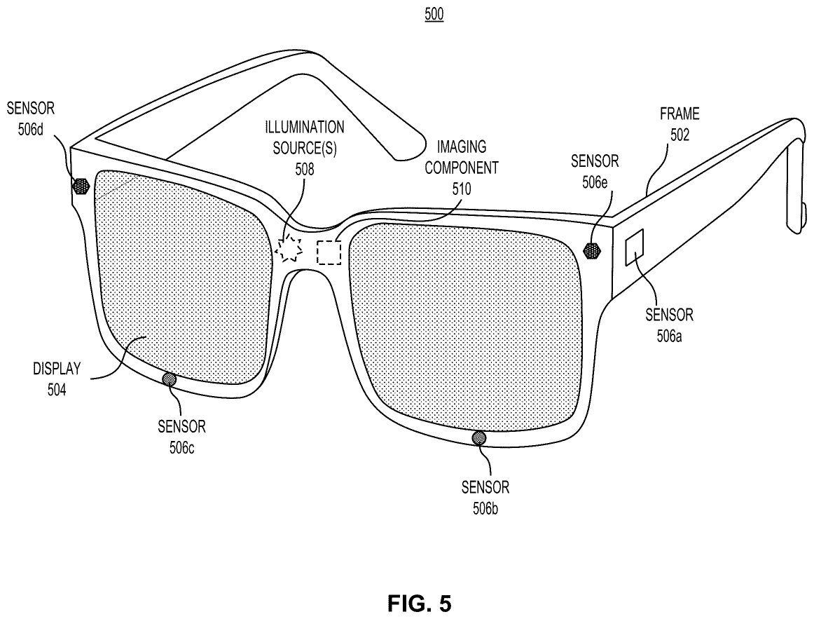

FIG. 5 illustrates a perspective view of a wearable eyewear device 500, such as a near-eye display, in the form of a pair of smartglasses, glasses, or other similar eyewear, according to an example. The wearable eyewear device 500 may be equivalent to the wearable eyewear device 300 depicted in FIG. 3. In some examples, the wearable eyewear device 500 may be configured to operate as a virtual reality display, an augmented reality display, and/or a mixed reality display. In some examples, the wearable eyewear device 500 may be eyewear, in which a user of the wearable eyewear device 500 may see through lenses in the wearable eyewear device 500.

In some examples, the wearable eyewear device 500 includes a frame 502 and a display 504. In some examples, the display 504 may be configured to present media or other content to a user. In some examples, the display 504 may include display electronics and/or display optics. For example, the display 504 may include a liquid crystal display (LCD) display panel, a light-emitting diode (LED) display panel, or an optical display panel (e.g., a waveguide display assembly). In some examples, the display 504 may also include any number of optical components, such as waveguides, gratings, lenses, mirrors, etc. In other examples, the display 504 may be omitted and instead, the wearable eyewear device 500 may include lenses that are transparent and/or tinted, such as sunglasses.

In some examples, the wearable eyewear device 500 may further include various sensors 506a, 506b, 506c, 506d, and 506e on or within the frame 502. In some examples, the various sensors 506a-506e may include any number of depth sensors, motion sensors, position sensors, inertial sensors, and/or ambient light sensors, as shown. In some examples, the various sensors 506a-506e may include any number of image sensors (e.g., imaging components) configured to generate image data representing different fields of views in one or more different directions. In some examples, the various sensors 506a-506e may be used as input devices to control or influence the displayed content of the wearable eyewear device 500, and/or to provide an interactive virtual reality (VR), augmented reality (AR), and/or mixed reality (MR) experience to a user of the wearable eyewear device 500. In some examples, the various sensors 506a-506e may also be used for stereoscopic imaging or other similar application. For instance, the sensors 506a-506e may capture the first and second images 122, 124 discussed herein.

In some examples, the wearable eyewear device 500 may further include one or more illumination sources 508 to project light into a physical environment. The projected light may be associated with different frequency bands (e.g., visible light, infra-red light, ultra-violet light, etc.), and may serve various purposes.

In some examples, the wearable eyewear device 500 may also include an imaging component 510. The imaging component 510 may capture images of the physical environment in the field of view of the imaging component 510. In some instances, the captured images may be processed, for example, by a virtual reality engine (not shown) to add virtual objects to the captured images or modify physical objects in the captured images, and the processed images may be displayed to the user by the display 504 for augmented reality (AR) and/or mixed reality (MR) applications. The captured images may also be used to determine a pattern 126 associated with an object of interest 120 as discussed herein.

The illumination source(s) 508 and the imaging component 510 may also or alternatively be directed to an eyebox as discussed herein and may be used to track a user's eye movements.

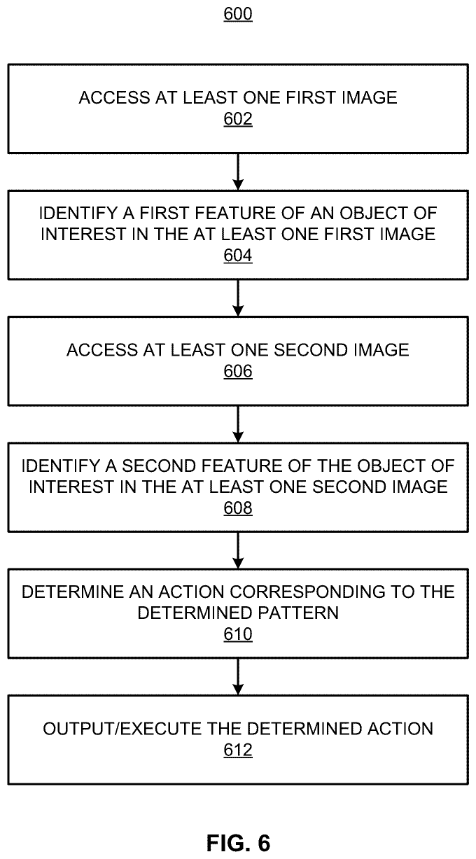

Various manners in which the processor 102 of the apparatus 100 may operate are discussed in greater detail with respect to the method 600 depicted in FIG. 6. FIG. 6 illustrates a flow diagram of a method 600 for determining a pattern associated with an object of interest 120 based on images of the object of interest 120, according to an example. It should be understood that the method 600 depicted in FIG. 6 may include additional operations and that some of the operations described therein may be removed and/or modified without departing from the scope of the method 600. The description of the method 600 is made with reference to the features depicted in FIGS. 1, 2A, and 2B for purposes of illustration.

At block 602, the processor 102 may access at least one first image 122 of an environment 200 captured by a wearable eyewear device 300 during a first time period. In some examples, the processor 102 may be part of the wearable eyewear device 300, while in other examples, the processor 102 may be part of an apparatus 100 that is separate from the wearable eyewear device 300.

At block 604, the processor 102 may identify a first feature 210 of an object of interest 120 in the at least one first image 122.

At block 606, the processor 102 may access at least one second image 124 of the environment 200 captured by the wearable eyewear device 300 during a second time period. In addition, at block 608, the processor 102 may identify a second feature 212 of the object of interest 120 in the at least one second image 124.

At block 608, the processor 102 may determine a pattern 126 associated with the object of interest 120 based on the identified first feature 210 and the identified second feature 212 of the identified object of interest 120. In some examples, the processor 102 may apply an artificial intelligence algorithm on the at least one first image and the at least one second image of the object of interest to determine the pattern. In addition, the processor 102 may determine the pattern 126 associated with the object of interest 120 as a rate at which a feature of the object of interest 120 has changed over time based on the first feature 210 in the at least one first image 122 of the object of interest 120 and the second feature 212 of the at least one second image 124 of the object of interest 120.

In some examples, the processor 102 may access at least one first sensed condition 312 in the environment 200 detected by a sensor 310 during the first time period. The processor 102 may also access at least one second sensed condition 314 in the environment 200 detected by the sensor 310 during the second time period. The processor 102 may further determine the pattern 126 associated with the object of interest 120 based also on the at least one first sensed condition 312 and the at least one second sensed condition 314.

In some examples, the processor 102 may access additional images of the environment 200 captured by the wearable eyewear device 300 during additional time periods. The processor 102 may also identify the object of interest 120 in the additional images and may update the pattern 126 associated with the object of interest 120 based on images of the identified object of interest 120 in the additional images.

At block 610, the processor 102 may determine an action corresponding to the determined pattern 126. In addition, at block 612, the processor 102 may output and/or execute the determined action. In some examples, the processor 102 may generate an item to be displayed from the determined action and may cause the item to be displayed on the wearable eyewear device 300.

Some or all of the operations set forth in the method 600 may be included as utilities, programs, or subprograms, in any desired computer accessible medium. In addition, the method 600 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

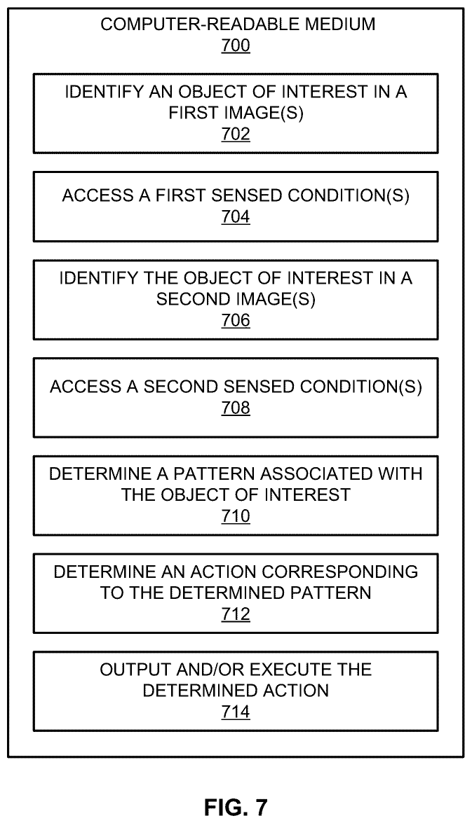

Turning now to FIG. 7, there is illustrated a block diagram of a computer-readable medium 700 that has stored thereon computer-readable instructions for determining a pattern 126 associated with an object of interest 120 based on images of the object of interest 120 captured by a wearable eyewear device 300, according to an example. It should be understood that the computer-readable medium 700 depicted in FIG. 7 may include additional instructions and that some of the instructions described herein may be removed and/or modified without departing from the scope of the computer-readable medium 700 disclosed herein. In some examples, the computer-readable medium 700 is a non-transitory computer-readable medium, in which the term “non-transitory” does not encompass transitory propagating signals.

The computer-readable medium 700 has stored thereon computer-readable instructions 702-714 that a processor, such as the processor 102 of the apparatus 100 depicted in FIG. 1 may execute. The computer-readable medium 700 may be an electronic, magnetic, optical, or other physical storage device that contains or stores executable instructions. The computer-readable medium 700 may be, for example, Random Access memory (RAM), an Electrically Erasable Programmable Read-Only Memory (EEPROM), a storage device, or an optical disc.

The processor may execute the instructions 702 to identify an object of interest 120 in at least one first image 122 of an environment 200 captured by a wearable eyewear device 300 during a first time period. The processor may execute the instructions 704 to access at least one first sensed condition 312 in the environment 200 detected by a sensor 310 during the first time period. The processor may and execute the instructions 706 to identify the object of interest 120 in at least one second image 124 of the environment 200 captured by the wearable eyewear device during a second time period. The processor may execute the instructions 708 to access at least one second sensed condition 314 in the environment 200 detected by the sensor 310 during the second time period.

The processor may execute the instructions 710 to determine a pattern 126 associated with the object of interest 120 based on the at least one first image 122 of the identified object of interest 120, the at least one second image 124 of the identified object of interest 120, the at least one first sensed condition 312, and the at least one second sensed condition 314. According to examples, the processor may apply an artificial intelligence algorithm on the at least one first image 122, the at least one second image 124, the at least one first sensed condition 312, and the at least one second sensed condition 314.

The processor may execute the instructions 712 to determine an action corresponding to the determined pattern 126. In addition, the processor may execute the instructions 714 to output and/or execute the determined action. For instance, the processor may generate an item to be displayed from the determined action and may cause the item to be displayed on the wearable eyewear device 300.

It should be noted that the functionality described herein may be subject to one or more privacy policies, described below, enforced by the apparatuses and methods described herein that may bar use of images for concept detection, recommendation, generation, and analysis.

In particular examples, one or more elements (e.g., content or other types of elements) of a computing system may be associated with one or more privacy settings. The one or more elements may be stored on or otherwise associated with any suitable computing system or application, such as, for example, the apparatus 100, the wearable eyewear device 300, 400, 500, a social-networking application, a messaging application, a photo-sharing application, or any other suitable computing system or application. Privacy settings (or “access settings”) for an element may be stored in any suitable manner, such as, for example, in association with the element, in an index on an authorization server, in another suitable manner, or any suitable combination thereof. A privacy setting for an element may specify how the element (or particular information associated with the element) can be accessed, stored, or otherwise used (e.g., viewed, shared, modified, copied, executed, surfaced, or identified) within the online social network. When privacy settings for an element allow a particular user or other entity to access that element, the element may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an element may specify a “blocked list” of users or other entities that should not be allowed to access certain information associated with the element. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the apparatus 100 or shared with other systems (e.g., an external system). Although this disclosure describes using particular privacy settings in a particular manner, this disclosure contemplates using any suitable privacy settings in any suitable manner.

In particular examples, the apparatus 100 and/or the wearable eyewear device 300 may present a “privacy wizard” (e.g., within a webpage, a module, one or more dialog boxes, or any other suitable interface) to a user to assist the user in specifying one or more privacy settings. The privacy wizard may display instructions, suitable privacy-related information, current privacy settings, one or more input fields for accepting one or more inputs from the user specifying a change or confirmation of privacy settings, or any suitable combination thereof. In particular examples, the apparatus 100 and/or the wearable eyewear device 300 may offer a “dashboard” functionality to the user that may display, to the user, current privacy settings of the user. The dashboard functionality may be displayed to the user at any appropriate time (e.g., following an input from the user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an element may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different elements of the same type associated with a user may have different privacy settings. Different types of elements associated with a user may have different types of privacy settings. As an example and not by way of limitation, a user may specify that the user's status updates are public, but any images shared by the user are visible only to the user's friends on the online social network. As another example and not by way of limitation, a user may specify different privacy settings for different types of entities, such as individual users, friends-of-friends, followers, user groups, or corporate entities. As another example and not by way of limitation, a user may specify a group of users that may view videos posted by the user, while keeping the videos from being visible to the user's employer. In particular examples, different privacy settings may be provided for different user groups or user demographics. As an example and not by way of limitation, a user may specify that other users who attend the same university as the user may view the user's pictures, but that other users who are family members of the user may not view those same pictures.

In particular examples, the apparatus 100 and/or the wearable eyewear device 300 may provide one or more default privacy settings for each element of a particular element-type. A privacy setting for an element that is set to a default may be changed by a user associated with that element. As an example and not by way of limitation, all images posted by a user may have a default privacy setting of being visible only to friends of the user and, for a particular image, the user may change the privacy setting for the image to be visible to friends and friends-of-friends.

In particular examples, privacy settings may allow a user to specify (e.g., by opting out, by not opting in) whether the apparatus 100 and/or the wearable eyewear device 300 may receive, collect, log, or store particular elements or information associated with the user for any purpose. In particular examples, privacy settings may allow the user to specify whether particular applications or processes may access, store, or use particular elements or information associated with the user. The privacy settings may allow the user to opt in or opt out of having elements or information accessed, stored, or used by specific applications or processes. The apparatus 100 and/or the wearable eyewear device 300 may access such information in order to provide a particular function or service to the user, without the apparatus 100 and/or the wearable eyewear device 300 having access to that information for any other purposes. Before accessing, storing, or using such elements or information, the apparatus 100 and/or the wearable eyewear device 300 may prompt the user to provide privacy settings specifying which applications or processes, if any, may access, store, or use the elements or information prior to allowing any such action. As an example and not by way of limitation, a user may transmit a message to a second user via an application related to the online social network (e.g., a messaging app), and may specify privacy settings that such messages should not be stored by the apparatus 100 and/or the wearable eyewear device 300.

In particular examples, a user may specify whether particular types of elements or information associated with the first user may be accessed, stored, or used by the apparatus 100. As an example and not by way of limitation, the user may specify that images sent by the user through the apparatus 100 and/or the wearable eyewear device 300 may not be stored by the apparatus 100 and/or the wearable eyewear device 300. As another example and not by way of limitation, a user may specify that messages sent from the user to a particular second user may not be stored by the apparatus 100 and/or the wearable eyewear device 300. As yet another example and not by way of limitation, a user may specify that all elements sent via a particular application may be saved by the apparatus 100 and/or the wearable eyewear device 300.

In particular examples, privacy settings may allow a user to specify whether particular elements or information associated with the user may be accessed from client devices or external systems. The privacy settings may allow the user to opt in or opt out of having elements or information accessed from a particular device (e.g., the phone book on a user's smart phone), from a particular application (e.g., a messaging app), or from a particular system (e.g., an email server). The apparatus 100 and/or the wearable eyewear device 300 may provide default privacy settings with respect to each device, system, or application, and/or the user may be prompted to specify a particular privacy setting for each context. As an example and not by way of limitation, the user may utilize a location-services feature of the apparatus 100 and/or the wearable eyewear device 300 to provide recommendations for restaurants or other places in proximity to the user. The user's default privacy settings may specify that the apparatus 100 and/or the wearable eyewear device 300 may use location information provided from a client device of the user to provide the location-based services, but that the apparatus 100 and/or the wearable eyewear device 300 may not store the location information of the user or provide it to any external system. The user may then update the privacy settings to allow location information to be used by a third-party image-sharing application in order to geo-tag photos.

In particular examples, privacy settings may allow a user to engage in the ephemeral sharing of elements on the online social network. Ephemeral sharing refers to the sharing of elements (e.g., posts, photos) or information for a finite period of time. Access or denial of access to the elements or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the apparatus 100 and/or the wearable eyewear device 300 may be restricted in its access, storage, or use of the elements or information. The apparatus 100 and/or the wearable eyewear device 300 may temporarily access, store, or use these particular elements or information in order to facilitate particular actions of a user associated with the elements or information, and may subsequently delete the elements or information, as specified by the respective privacy settings. As an example and not by way of limitation, a user may transmit a message to a second user, and the apparatus 100 and/or the wearable eyewear device 300 may temporarily store the message in a content data store until the second user has viewed or downloaded the message, at which point the apparatus 100 and/or the wearable eyewear device 300 may delete the message from the data store. As another example and not by way of limitation, continuing with the prior example, the message may be stored for a specified period of time (e.g., 2 weeks), after which point the apparatus 100 and/or the wearable eyewear device 300 may delete the message from the content data store.

In particular examples, privacy settings may allow a user to specify one or more geographic locations from which elements can be accessed. Access or denial of access to the elements may depend on the geographic location of a user who is attempting to access the objects. As an example and not by way of limitation, a user may share an element and specify that only users in the same city may access or view the element. As another example and not by way of limitation, a first user may share an element and specify that the element is visible to second users only while the user is in a particular location. If the user leaves the particular location, the element may no longer be visible to the second users. As another example and not by way of limitation, a user may specify that an element is visible only to second users within a threshold distance from the user. If the user subsequently changes location, the original second users with access to the element may lose access, while a new group of second users may gain access as they come within the threshold distance of the user.

In particular examples, the apparatus 100 and/or the wearable eyewear device 300 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the apparatus 100 and/or the wearable eyewear device 300. The user's privacy settings may specify that such information may be used only for particular processes, such as authentication, and further specify that such information may not be shared with any external system or used for other processes or applications associated with the apparatus 100 and/or the wearable eyewear device 300. As another example and not by way of limitation, the apparatus 100 and/or the wearable eyewear device 300 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the apparatus 100 and/or the wearable eyewear device 300. As another example and not by way of limitation, the apparatus 100 and/or the wearable eyewear device 300 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the apparatus 100 and/or the wearable eyewear device 300.

In particular examples, changes to privacy settings may take effect retroactively, affecting the visibility of elements and content shared prior to the change. As an example and not by way of limitation, a user may share a first image and specify that the first image is to be public to all other users. At a later time, the user may specify that any images shared by the user should be made visible only to a user group. The apparatus 100 and/or the wearable eyewear device 300 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the apparatus 100 and/or the wearable eyewear device 300 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the apparatus 100 and/or the wearable eyewear device 300 may determine that a user may want to change one or more privacy settings in response to a trigger action associated with the user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the apparatus 100 and/or the wearable eyewear device 300 may prompt the user to change the privacy settings regarding the visibility of elements associated with the user. The prompt may redirect the user to a workflow process for editing privacy settings with respect to one or more entities associated with the trigger action. The privacy settings associated with the user may be changed only in response to an explicit input from the user, and may not be changed without the approval of the user. As an example and not by way of limitation, the workflow process may include providing the user with the current privacy settings with respect to the second user or to a group of users (e.g., un-tagging the user or second user from particular objects, changing the visibility of particular objects with respect to the second user or group of users), and receiving an indication from the user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the apparatus 100 and/or the wearable eyewear device 300 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the apparatus 100 and/or the wearable eyewear device 300 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the apparatus 100 and/or the wearable eyewear device 300 may send a reminder to the user to confirm his or her privacy settings every six months or after every ten photo posts. In particular examples, privacy settings may also allow users to control access to the objects or information on a per-request basis. As an example and not by way of limitation, the apparatus 100 and/or the wearable eyewear device 300 may notify the user whenever an external system attempts to access information associated with the user, and require the user to provide verification that access should be allowed before proceeding.

As used herein, a waveguide (or “waveguide configuration”) may refer to any optical structure that may propagate a variety of signals (e.g., optical signals, electromagnetic waves, sound waves, etc.) in one or more directions. In some examples, the waveguide may the optical signal from a first location to a second location. In particular, in some examples, the waveguide may receive, guide, and eject the optical signal outside of the optical medium in a controlled and efficient manner. Employing principles of physics, information contained in such signals, may be directed using any number of waveguides or similar components.

In some examples, waveguides may implement one or more optical technologies. For example, in some instances, a first type of waveguide may be a “diffractive” waveguide, wherein the waveguide may utilize diffraction principals to guide the light wave into, through, and out of the waveguide.

In some examples, a performance issue that may arise in implementation of diffractive waveguides may be a presence of one or more artifacts. As used herein, an “artifact” may include a physical or non-physical aspect that may be associated with a drop in efficiency of an optical device. In particular, in some instances, an artifact may decrease brightness associated with an optical component (e.g., a transparent lens with one or more embedded waveguides). In some instances, this decreased brightness may require an increase in power expended by the optical device in order to project a light signal.

In some instances, another drawback in implementation of diffractive waveguides may be that the implementation may be wavelength-dependent. In particular, in some examples, operation of the diffractive waveguide may occur with (only) respect to a particular wavelength or wavelength range.

In some examples, another type of waveguide may be a “reflective” or “geometric” waveguide. In some examples, the geometric waveguide may implement reflection of the light wave to guide a light wave through an optical medium (e.g., located in an optical device). In particular, in some examples and as discussed further below, the geometric waveguide may comprise a cascade (i.e., a plurality) of reflective mirrors that may reflect the light from a first location to a second location.

In some examples, a geometric waveguide may provide a number of advantages. For example, in some instances, a geometric waveguide may be relatively artifact-free. Therefore, when for example, the geometric waveguide may be in implemented in a display device, this may enable a display component of the display device to be significantly brighter.

In addition, in some examples, a geometric waveguide may be wavelength-agonistic. That is, in some examples, the geometric waveguide may be implemented with respect to a variety of wavelength settings, and therefore may provide greater flexibility during design and manufacturing phases of an associated product or device.

In some examples, a display device may utilize a physical medium through which light may be projected (e.g., a lens on a virtual reality headset). In some examples, this physical medium may be comprised of transparent, crystalline glass. In some examples and among other things, the transparency and rigidity that glass may offer may be beneficial.

In other instances, a physical medium may be comprised of one or more polymers (i.e., “optical-grade” polymers). In some examples, these polymers may exhibit (i.e., offer) a large variety of material properties. Moreover, in many instances, implementation of polymers may be relatively inexpensive (e.g., compared to glass).

In some examples, polymers may be categorized to include thermoplastics and thermosets. In some examples, a thermoplastic polymer may be shaped via application of heat. That is, in some examples, application of heat to the polymer may enable the polymer material to become “shape-able” (i.e., bend-able, pliable, etc.). In some examples, in the case of thermoset polymers, upon setting of a shape, the shape may not be altered thereafter.

Accordingly, it may be appreciated that implementations of thermoplastic polymers may offer significant advantages. In some examples, the ability to shape (and re-shape) a thermoplastic polymer may make manufacturing processes of optical devices (e.g., display devices) significantly more flexible and simple. Also, in some instances, thermoset polymers may provide significant advantages as well. For examples, in some instances, it may be advantageous to utilize the rigidity that a thermoset component may offer.

In some examples, a thermoplastic polymer component (e.g., a geometric waveguide) may be produced via use of an injection molding process. In some examples, an injection molding process may include molten material according to predetermined shape, or mold. As used herein, a mold may include any object that may be used to produce (e.g., shape) another object. In various examples, injection molding may be implemented on a variety of thermoplastic polymers.

In some examples, to produce a thermoplastic polymer component, a first injection-molded layer may be layered (i.e., attached) on top of a second injection-molded layer. In some examples, to layer a first layer on top of the second layer, existing methods may require injection molding the first layer and the second layer, and then bonding (e.g., gluing) the first layer to the second layer. As such, in these examples, the attaching of the first layer to the second layer may necessitate an intermediate, “bonding” layer (e.g., comprised of an optically clear adhesive layer).

In some instances, a bonding layer may present problems in performance of a polymer component. In particular, in some examples, since the material property of the bonding layer may be different that the material property of the first layer and the second layer, this may result in a non-uniformity that may impact performance negatively (e.g., during transmission of an optical signal). Accordingly, it may be appreciated that methods and systems for manufacturing and producing of polymeric components that may avoid these drawbacks may be desirable.

Systems and methods as described may be directed to manufacturing and producing of polymeric components. In some examples, the systems and methods may utilize one or more casting procedures to produce a polymeric component. In some examples, and as used herein, “casting” may include one or more manufacturing processes that may include pouring a liquid material into a mold or predefined shape. In some examples, the mold may comprise a hollow cavity of a desired shape. In some examples, the casting may further include allowing to the poured liquid material to solidify.

In some examples, the systems and methods may produce the polymeric component by casting another polymeric component on top of an existing polymeric component. In some instances, and as described herein, this may be referred to as “overcasting.”

In some examples and as will be discussed further below, a casting procedure may be utilized to produce a first portion of a polymeric component. In some examples, a mold may be utilized to cast the first portion of the polymeric component.

In some examples, the systems and methods may include a coating procedure. In particular, for example, upon producing (e.g., casting) of the first portion of a polymeric component, the systems and methods may include a coating procedure wherein the first portion of the polymeric component may be coated. In some examples, the first portion of the polymeric component may be coated with a material coating having particular and/or specified reflective characteristics.

In some examples, a coated surface of the first portion of the polymeric component may be utilized to produce one or more mirror structures. In some examples and as described further below, the one or more mirror structures may be utilized to produce a (e.g., geometric) waveguide.

In some examples, upon coating of a first portion of a polymeric component, a second portion of the polymeric component may be overcast over the first portion of the polymeric component to produce the polymeric component. In some instances, the polymeric component including the first portion and the second portion may also be referred to as a “composite polymeric component.”

In some examples, a mold (e.g., made of metal, glass, plastic, etc.) may be utilized to overcast a second portion of a polymeric component on top of a first portion of a polymeric component. Furthermore, in some examples, by overcasting the second of the portion of the polymeric component on top of the first portion of the polymeric component, one or more mirror structures (e.g., coated on top of the first portion of the polymeric component) may be embedded in the polymeric component.

In some examples, the systems and methods may include a display system, comprising a processor and a memory storing instructions, which when executed by the processor, may cause the processor to implement a casting process to produce a first polymer layer, wherein the first polymer layer is supported on a substrate, apply a coating on a surface of the first polymer layer to form one or more mirror structures, and implement an overcasting process to attach a second polymer layer to the first polymer layer to form a composite polymer component. In some examples, the instructions when executed by the processor may further cause the processor to selectively remove a portion of the coating on the surface of the first polymer layer, enable a release of the composite polymer component from the substrate, and provide error compensation with respect to the composite polymer component. Also, in some examples, the error compensation may comprise planarizing, and the composite polymer component may be implemented in a geometric waveguide. In addition, in some examples, the first polymer layer may comprise one or more facets upon which the coating is applied, and the coating may be applied by transitioning from a lesser amount on a first portion of the first polymer layer to a greater amount on a second portion of the first polymer layer.

In some examples, the systems and methods may include a method for manufacturing a composite polymer component for a display device, comprising implementing a casting process to produce a first polymer layer, wherein the first polymer layer is supported on a substrate, applying a coating on a surface of the first polymer layer to form one or more mirror structures, and implementing an overcasting process to attach a second polymer layer to the first polymer layer to form a composite polymer component. In some examples, the systems and methods may include a non-transitory computer-readable storage medium having an executable stored thereon, which when executed may instruct a processor to implement a casting process to produce a first polymer layer, wherein the first polymer layer may be supported on a substrate, apply a coating on a surface of the first polymer layer to form one or more mirror structures, and implement an overcasting process to attach a second polymer layer to the first polymer layer to form a composite polymer component.

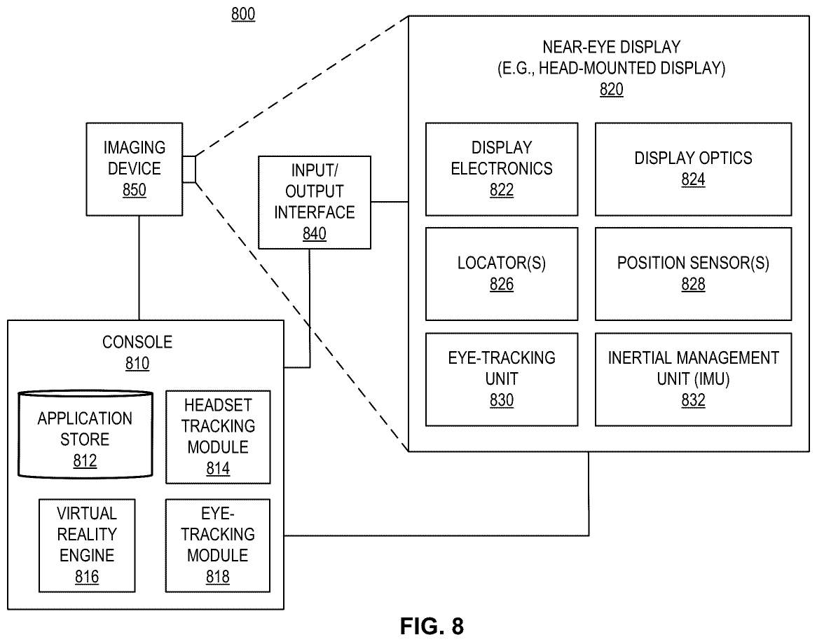

FIG. 8 illustrates a block diagram of an artificial reality system environment 800 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.” In some examples, the artificial reality environment 800 may implement a geometric waveguide produced via the systems and methods described herein.

As shown in FIG. 8, the artificial reality system environment 800 may include a near-eye display 820, an optional external imaging device 850, and an optional input/output interface 840, each of which may be coupled to a console 810. The console 810 may be optional in some instances as the functions of the console 810 may be integrated into the near-eye display 820. In some examples, the near-eye display 820 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (e.g., for binocular head-mounted displays (HMDs)). Also, as used herein, an “eyebox” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eyebox.

In some examples, the near-eye display 820 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

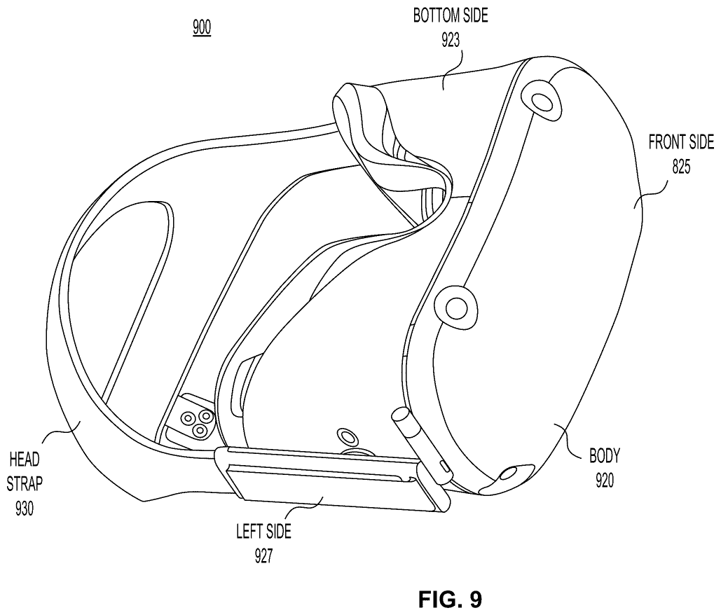

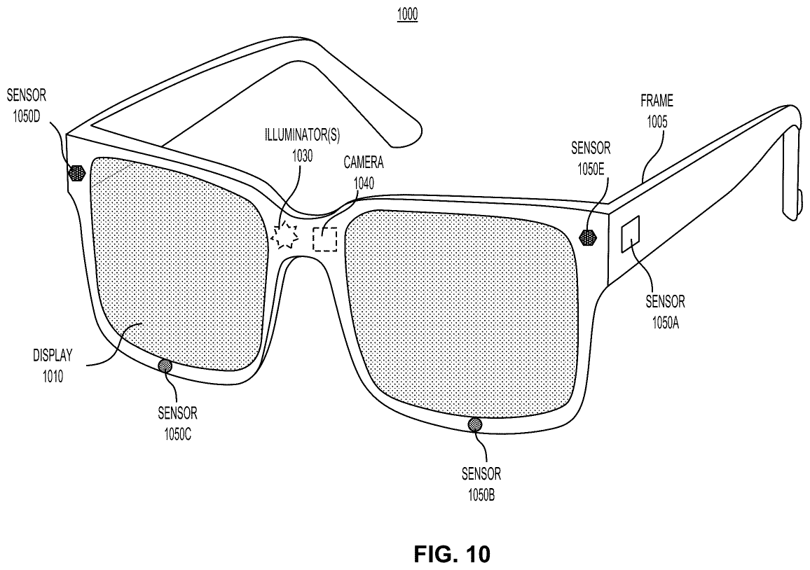

In some examples, the near-eye display 820 may be implemented in any suitable form-factor, including a head-mounted display (HMD), a pair of glasses, or other similar wearable eyewear or device. Examples of the near-eye display 820 are further described below with respect to FIGS. 9 and 10. Additionally, in some examples, the functionality described herein may be used in a HMD or headset that may combine images of an environment external to the near-eye display 820 and artificial reality content (e.g., computer-generated images). Therefore, in some examples, the near-eye display 820 may augment images of a physical, real-world environment external to the near-eye display 820 with generated and/or overlaid digital content (e.g., images, video, sound, etc.) to present an augmented reality to a user.

In some examples, the near-eye display 820 may include any number of display electronics 822, display optics 824, and an eye-tracking unit 830. In some examples, the near-eye display 820 may also include one or more locators 826, one or more position sensors 828, and an inertial measurement unit (IMU) 832. In some examples, the near-eye display 820 may omit any of the eye-tracking unit 830, the one or more locators 826, the one or more position sensors 828, and the inertial measurement unit (IMU) 832, or may include additional elements.

In some examples, the display electronics 822 may display or facilitate the display of images to the user according to data received from, for example, the optional console 810. In some examples, the display electronics 822 may include one or more display panels. In some examples, the display electronics 822 may include any number of pixels to emit light of a predominant color such as red, green, blue, white, or yellow. In some examples, the display electronics 822 may display a three-dimensional (3D) image, e.g., using stereoscopic effects produced by two-dimensional panels, to create a subjective perception of image depth.

In some examples, the display optics 824 may display image content optically (e.g., using optical waveguides and/or couplers) or magnify image light received from the display electronics 822, correct optical errors associated with the image light, and/or present the corrected image light to a user of the near-eye display 820. In some examples, the display optics 824 may include a single optical element or any number of combinations of various optical elements as well as mechanical couplings to maintain relative spacing and orientation of the optical elements in the combination. In some examples, one or more optical elements in the display optics 824 may have an optical coating, such as an anti-reflective coating, a reflective coating, a filtering coating, and/or a combination of different optical coatings.

In some examples, the display optics 824 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 826 may be objects located in specific positions relative to one another and relative to a reference point on the near-eye display 820. In some examples, the optional console 810 may identify the one or more locators 826 in images captured by the optional external imaging device 850 to determine the artificial reality headset's position, orientation, or both. The one or more locators 826 may each be a light-emitting diode (LED), a corner cube reflector, a reflective marker, a type of light source that contrasts with an environment in which the near-eye display 820 operates, or any combination thereof.

In some examples, the external imaging device 850 may include one or more cameras, one or more video cameras, any other device capable of capturing images including the one or more locators 826, or any combination thereof. The optional external imaging device 850 may be configured to detect light emitted or reflected from the one or more locators 826 in a field of view of the optional external imaging device 850.

In some examples, the one or more position sensors 828 may generate one or more measurement signals in response to motion of the near-eye display 820. Examples of the one or more position sensors 828 may include any number of accelerometers, gyroscopes, magnetometers, and/or other motion-detecting or error-correcting sensors, or any combination thereof.

In some examples, the inertial measurement unit (IMU) 832 may be an electronic device that generates fast calibration data based on measurement signals received from the one or more position sensors 828. The one or more position sensors 828 may be located external to the inertial measurement unit (IMU) 832, internal to the inertial measurement unit (IMU) 832, or any combination thereof. Based on the one or more measurement signals from the one or more position sensors 828, the inertial measurement unit (IMU) 832 may generate fast calibration data indicating an estimated position of the near-eye display 820 that may be relative to an initial position of the near-eye display 820. For example, the inertial measurement unit (IMU) 832 may integrate measurement signals received from accelerometers over time to estimate a velocity vector and integrate the velocity vector over time to determine an estimated position of a reference point on the near-eye display 820. Alternatively, the inertial measurement unit (IMU) 832 may provide the sampled measurement signals to the optional console 810, which may determine the fast calibration data.

The eye-tracking unit 830 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 830 may capture reflected radio waves emitted by a miniature radar unit. These data associated with the eye may be used to determine or predict eye position, orientation, movement, location, and/or gaze.

In some examples, the near-eye display 820 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 830 may be able to determine where the user is looking or predict any user patterns, etc.

In some examples, the input/output interface 840 may be a device that allows a user to send action requests to the optional console 810. As used herein, an “action request” may be a request to perform a particular action. For example, an action request may be to start or to end an application or to perform a particular action within the application. The input/output interface 840 may include one or more input devices. Example input devices may include a keyboard, a mouse, a game controller, a glove, a button, a touch screen, or any other suitable device for receiving action requests and communicating the received action requests to the optional console 810. In some examples, an action request received by the input/output interface 840 may be communicated to the optional console 810, which may perform an action corresponding to the requested action.

In some examples, the optional console 810 may provide content to the near-eye display 820 for presentation to the user in accordance with information received from one or more of external imaging device 850, the near-eye display 820, and the input/output interface 840. For example, in the example shown in FIG. 8, the optional console 810 may include an application store 812, a headset tracking module 814, a virtual reality engine 816, and an eye-tracking module 818. Some examples of the optional console 810 may include different or additional modules than those described in conjunction with FIG. 8. Functions further described below may be distributed among components of the optional console 810 in a different manner than is described here.

In some examples, the optional console 810 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 810 described in conjunction with FIG. 8 may be encoded as instructions in the non-transitory computer-readable storage medium that, when executed by the processor, cause the processor to perform the functions further described below. It should be appreciated that the optional console 810 may or may not be needed or the optional console 810 may be integrated with or separate from the near-eye display 820.

In some examples, the application store 812 may store one or more applications for execution by the optional console 810. An application may include a group of instructions that, when executed by a processor, generates content for presentation to the user. Examples of the applications may include gaming applications, conferencing applications, video playback application, or other suitable applications.

In some examples, the headset tracking module 814 may track movements of the near-eye display 820 using slow calibration information from the external imaging device 850. For example, the headset tracking module 814 may determine positions of a reference point of the near-eye display 820 using observed locators from the slow calibration information and a model of the near-eye display 820. Additionally, in some examples, the headset tracking module 814 may use portions of the fast calibration information, the slow calibration information, or any combination thereof, to predict a future location of the near-eye display 820. In some examples, the headset tracking module 814 may provide the estimated or predicted future position of the near-eye display 820 to the virtual reality engine 816.

In some examples, the virtual reality engine 816 may execute applications within the artificial reality system environment 800 and receive position information of the near-eye display 820, acceleration information of the near-eye display 820, velocity information of the near-eye display 820, predicted future positions of the near-eye display 820, or any combination thereof from the headset tracking module 814. In some examples, the virtual reality engine 816 may also receive estimated eye position and orientation information from the eye-tracking module 818. Based on the received information, the virtual reality engine 816 may determine content to provide to the near-eye display 820 for presentation to the user.

In some examples, the eye-tracking module 818 may receive eye-tracking data from the eye-tracking unit 830 and determine the position of the user's eye based on the eye tracking data. In some examples, the position of the eye may include an eye's orientation, location, or both relative to the near-eye display 820 or any element thereof. So, in these examples, because the eye's axes of rotation change as a function of the eye's location in its socket, determining the eye's location in its socket may allow the eye-tracking module 818 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 9 illustrates a perspective view of a near-eye display in the form of a head-mounted display (HMD) device 900, according to an example. In some examples, the head-mounted display (HMD) device 900 may be a part of a virtual reality (VR) system, an augmented reality (AR) system, a mixed reality (MR) system, another system that uses displays or wearables, or any combination thereof. In some examples, the head-mounted display (HMD) device 900 may include a body 920 and a head strap 930. FIG. 9 shows a bottom side 923, a front side 925, and a left side 927 of the body 920 in the perspective view. In some examples, the head strap 930 may have an adjustable or extendible length. In particular, in some examples, there may be a sufficient space between the body 920 and the head strap 930 of the head-mounted display (HMD) device 900 for allowing a user to mount the head-mounted display (HMD) device 900 onto the user's head. In some examples, the head-mounted display (HMD) device 900 may include additional, fewer, and/or different components. In some examples, the head-mounted display (HMD) device 900 may implement a geometric waveguide produced via the systems and methods described herein.

In some examples, the head-mounted display (HMD) device 900 may present, to a user, media or other digital content including virtual and/or augmented views of a physical, real-world environment with computer-generated elements. Examples of the media or digital content presented by the head-mounted display (HMD) device 900 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 9) enclosed in the body 920 of the head-mounted display (HMD) device 900.

In some examples, the head-mounted display (HMD) device 900 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 900 may include an input/output interface 840 for communicating with a console 810, as described with respect to FIG. 8. In some examples, the head-mounted display (HMD) device 900 may include a virtual reality engine (not shown), but similar to the virtual reality engine 816 described with respect to FIG. 8, that may execute applications within the head-mounted display (HMD) device 900 and receive depth information, position information, acceleration information, velocity information, predicted future positions, or any combination thereof of the head-mounted display (HMD) device 900 from the various sensors.

In some examples, the information received by the virtual reality engine 816 may be used for producing a signal (e.g., display instructions) to the one or more display assemblies. In some examples, the head-mounted display (HMD) device 900 may include locators (not shown), but similar to the virtual locators 826 described in FIG. 8, which may be located in fixed positions on the body 920 of the head-mounted display (HMD) device 900 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 10 is a perspective view of a near-eye display 1000 in the form of a pair of glasses (or other similar eyewear), according to an example. In some examples, the near-eye display 1000 may be a specific implementation of near-eye display 820 of FIG. 8, and may be configured to operate as a virtual reality display, an augmented reality display, and/or a mixed reality display. In some examples, the near-eye display 1000 may implement a geometric waveguide produced via the systems and methods described herein.

In some examples, the near-eye display 1000 may include a frame 1005 and a display 1010. In some examples, the display 1010 may be configured to present media or other content to a user. In some examples, the display 1010 may include display electronics and/or display optics, similar to components described with respect to FIGS. 8-9. For example, as described above with respect to the near-eye display 820 of FIG. 8, the display 1010 may include a liquid crystal display (LCD) display panel, a light-emitting diode (LED) display panel, or an optical display panel (e.g., a waveguide display assembly). In some examples, the display 1010 may also include any number of optical components, such as waveguides, gratings, lenses, mirrors, etc.

In some examples, the near-eye display 1000 may further include various sensors 1050a, 1050b, 1050c, 1050d, and 1050e on or within a frame 1005. In some examples, the various sensors 1050a-1050e may include any number of depth sensors, motion sensors, position sensors, inertial sensors, and/or ambient light sensors, as shown. In some examples, the various sensors 1050a-1050e may include any number of image sensors configured to generate image data representing different fields of views in one or more different directions. In some examples, the various sensors 1050a-1050e may be used as input devices to control or influence the displayed content of the near-eye display 1000, and/or to provide an interactive virtual reality (VR), augmented reality (AR), and/or mixed reality (MR) experience to a user of the near-eye display 1000. In some examples, the various sensors 1050a-1050e may also be used for stereoscopic imaging or other similar application.

In some examples, the near-eye display 1000 may further include one or more illuminators 1030 to project light into a physical environment. The projected light may be associated with different frequency bands (e.g., visible light, infra-red light, ultra-violet light, etc.), and may serve various purposes. In some examples, the one or more illuminators 1030 may be used as locators, such as the one or more locators 826 described above with respect to FIGS. 8-9.

In some examples, the near-eye display 1000 may also include a camera 1040 or other image capture unit. The camera 1040, for instance, may capture images of the physical environment in the field of view. In some instances, the captured images may be processed, for example, by a virtual reality engine (e.g., the virtual reality engine 816 of FIG. 8) to add virtual objects to the captured images or modify physical objects in the captured images, and the processed images may be displayed to the user by the display 1010 for augmented reality (AR) and/or mixed reality (MR) applications.

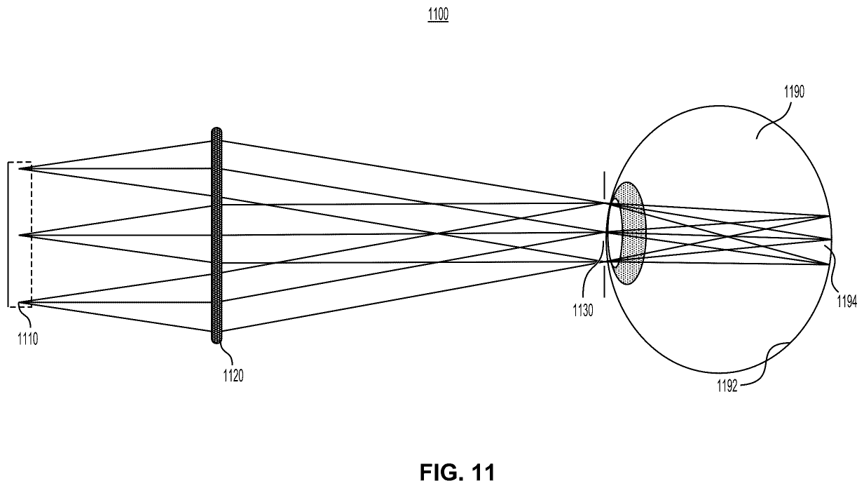

FIG. 11 illustrates a schematic diagram of an optical system 1100 in a near-eye display system, according to an example. In some examples, the optical system 1100 may include an image source 1110 and any number of projector optics 1120 (which may include waveguides having gratings as discussed herein). In the example shown in FIG. 11, the image source 1110 may be positioned in front of the projector optics 1120 and may project light toward the projector optics 1120. In some examples, the image source 1110 may be located outside of the field of view (FOV) of a user's eye 1190. In this case, the projector optics 1120 may include one or more reflectors, refractors, or directional couplers that may deflect light from the image source 1110 that is outside of the field of view (FOV) of the user's eye 1190 to make the image source 1110 appear to be in front of the user's eye 1190. Light from an area (e.g., a pixel or a light emitting device) on the image source 1110 may be collimated and directed to an exit pupil 1130 by the projector optics 1120. In some examples, the exit pupil 1130 may have a diameter of three (3) millimeters (mm). Thus, objects at different spatial locations on the image source 1110 may appear to be objects far away from the user's eye 1190 in different viewing angles (i.e., fields of view (FOV)). The collimated light from different viewing angles may then be focused by the lens of the user's eye 1190 onto different locations on retina 1192 of the user's eye 1190. For example, at least some portions of the light may be focused on a fovea 1194 on the retina 1192. Collimated light rays from an area on the image source 1110 and incident on the user's eye 1190 from a same direction may be focused onto a same location on the retina 1192. As such, a single image of the image source 1110 may be formed on the retina 1192.

In some instances, a user experience of using an artificial reality system may depend on several characteristics of the optical system, including field of view (FOV), image quality (e.g., angular resolution), size of the eyebox (to accommodate for eye and head movements), and brightness of the light (or contrast) within the eyebox. Also, in some examples, to create a fully immersive visual environment, a large field of view (FOV) may be desirable because a large field of view (FOV) (e.g., greater than about 60⁰) may provide a sense of “being in” an image, rather than merely viewing the image. In some instances, smaller fields of view may also preclude some important visual information. For example, a head-mounted display (HMD) system with a small field of view (FOV) may use a gesture interface, but users may not readily see their hands in the small field of view (FOV) to be sure that they are using the correct motions or movements. On the other hand, wider fields of view may require larger displays or optical systems, which may influence the size, weight, cost, and/or comfort of the head-mounted display (HMD) itself.

In some examples, a waveguide may be utilized to couple light into and/or out of a display system. In particular, in some examples and as described further below, light of projected images may be coupled into or out of the waveguide using any number of reflective or diffractive optical elements, such as gratings.

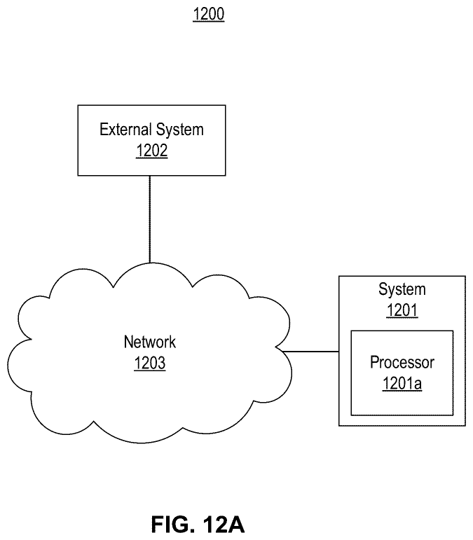

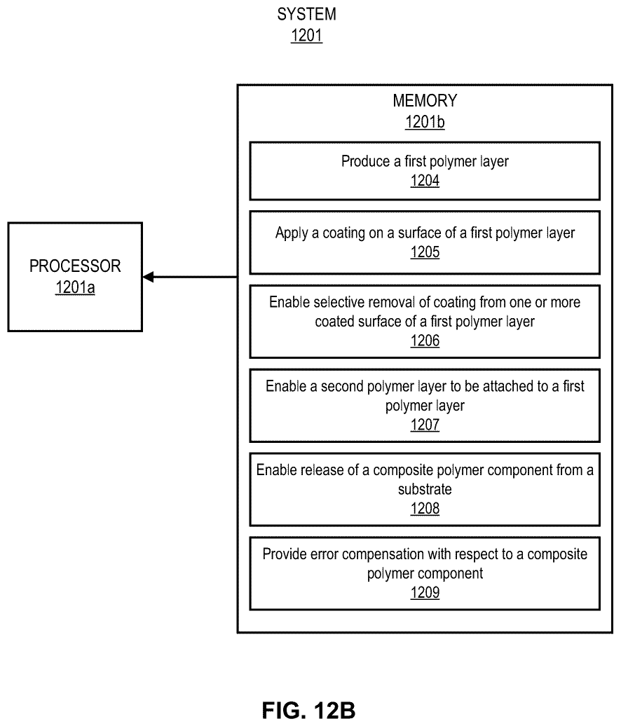

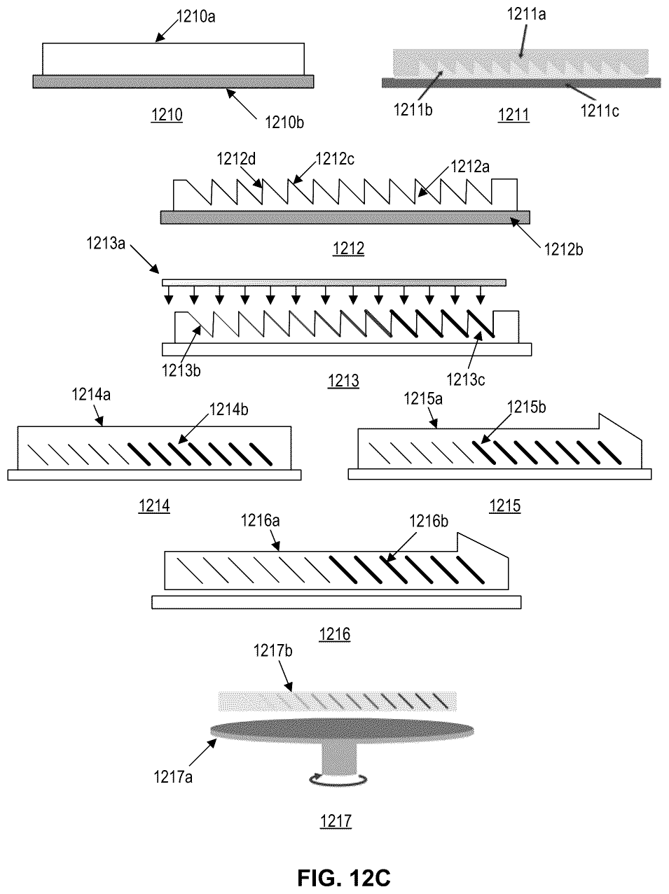

Reference is now made to FIGS. 12A-12C. FIG. 12A illustrates a block diagram of a system environment, including a system, that may be implemented for manufacturing and producing of optical devices having polymeric components, according to an example. FIG. 12B illustrates a block diagram of the system that may be implemented for manufacturing and producing of optical devices having polymeric components, according to an example. FIG. 12C illustrates diagrams of various aspects of a system that may be implemented for manufacturing and producing of optical devices having polymeric components, according to an example.

As will be described in the examples below, one or more of system 1201, external system 1202, and system environment 1200 shown in FIGS. 12A-12B may be operated by a service provider to generate and implement manufacturing and producing of polymeric components. It should be appreciated that one or more of the system 1201, the external system 1202, and the system environment 1200 depicted in FIGS. 12A-12B may be provided as examples. Thus, one or more of the system 1201, the external system 1202, and the system environment 1200 may or may not include additional features and some of the features described herein may be removed and/or modified without departing from the scopes of the system 1201, the external system 1202, and the system environment 1200 outlined herein.

While the servers, systems, subsystems, and/or other computing devices shown in FIGS. 12A-12C may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 1201, the external system 1202, or the system environment 1200.

In some examples, the external system 1202 may include any number of servers, hosts, systems, and/or databases that store data to be accessed by the system 1201, and/or other network elements (not shown) in the system environment 1200. In addition, in some examples, the servers, hosts, systems, and/or databases of the external system 1202 may include one or more storage mediums storing any data. In some examples, and as will be discussed further below, the external system 1202 may be utilized to store any information that may relate to manufacturing and producing of polymeric components.

The system environment 1200 may also include the network 1203. In operation, one or more of the system 1200, the external system 1202 and may communicate with one or more of the other devices via the network 1203. The network 1203 may be a local area network (LAN), a wide area network (WAN), the Internet, a cellular network, a cable network, a satellite network, or other network that facilitates communication between, the system 1200, the external system 1202, and/or any other system, component, or device connected to the network 1203. The network 1203 may further include one, or any number, of the exemplary types of networks mentioned above operating as a stand-alone network or in cooperation with each other. For example, the network 1203 may utilize one or more protocols of one or more clients or servers to which they are communicatively coupled. The network 1203 may facilitate transmission of data according to a transmission protocol of any of the devices and/or systems in the network 1203. Although the network 1203 is depicted as a single network in the system environment 1200 of FIG. 12A, it should be appreciated that, in some examples, the network 1203 may include a plurality of interconnected networks as well.

In some examples, and as will be discussed further below, the system 1200 may provide manufacturing and producing of polymeric components. Details of the system 1200 and its operation within the system environment 1200 will be described in more detail below.

As shown in FIGS. 12A-12B, the system 1200 may include processor 501a and the memory 501b. In some examples, the processor 501a may execute the machine-readable instructions stored in the memory 501b. It should be appreciated that the processor 501a may be a semiconductor-based microprocessor, a central processing unit (CPU), an application specific integrated circuit (ASIC), a field-programmable gate array (FPGA), and/or other suitable hardware device.

In some examples, the memory 1201b may have stored thereon machine-readable instructions (which may also be termed computer-readable instructions) that the processor 1201a may execute. The memory 1201b may be an electronic, magnetic, optical, or other physical storage device that contains or stores executable instructions. The memory 1201b may be, for example, random access memory (RAM), an Electrically Erasable Programmable Read-Only Memory (EEPROM), a storage device, an optical disc, or the like. The memory 1201b, which may also be referred to as a computer-readable storage medium, may be a non-transitory machine-readable storage medium, where the term “non-transitory” does not encompass transitory propagating signals. It should be appreciated that the memory 1201b depicted in FIGS. 12A-12B may be provided as an example. Thus, the memory 1201b may or may not include additional features, and some of the features described herein may be removed and/or modified without departing from the scope of the memory 1201b outlined herein.

It should be appreciated that, and as described further below, the processing performed via the instructions on the memory 1201b may or may not be performed, in part or in total, with the aid of other information and data, such as information and data provided by the external system 1202. Moreover, and as described further below, it should be appreciated that the processing performed via the instructions on the memory 1201b may or may not be performed, in part or in total, with the aid of or in addition to processing provided by other devices, including for example, the external system 1202.

In some examples, the memory 1201b may store instructions, such as instructions 1204-1209, which when executed by the processor 1201a, may cause the processor to: produce a first polymer layer; apply a coating on a surface of a first polymer layer; selective removal of a coating from one or more coated surfaces of a polymer layer; attach a second polymer layer on a first polymer layer; release a composite polymer component from a substrate; and provide error compensation with respect to a composite polymer component.

In some examples, the instructions 1204 may produce a first polymer layer. In some examples, the first polymer layer may serve as a base layer for a composite polymeric component, such as a geometric waveguide to be included in a display device.

In some examples, the instructions 1204 may produce a first polymer layer to be comprised of polymer resin. In some examples, the polymer resin may be transparent, and may be a monomer liquid. In some examples, the instructions 1204 may enable a polymer resin (e.g., a transparent monomer liquid polymer resin) to be dispensed (e.g., poured) on a diamond-turned mold (e.g., with a defined geometry). At this point, in some examples, the polymer resin may then to be “set” (e.g., cured) into a variety of (e.g., predetermined) shapes and/or profiles. For example, in some instances, the polymer resin may be poured into a cavity or other receiving shape that may be defined by the mold. Optionally, in some examples, a substrate may then be placed on top of the polymer resin and mold.

In some examples, the instructions 1204 may fabricate a first polymer layer on top of a substrate. For instance, as shown in 1210, the first polymer layer 1210a may rest (i.e., be attached to) on top of the substrate 1210b. In some examples, the substrate 1210b may be comprised of glass. In other examples, the substrate 1210b may be comprised of any number of other rigid materials.

In addition, in some examples, the instructions 1204 may produce a mold that may be utilized to produce a first polymer layer. In particular, in some examples, the instructions 1204 may enable the mold to be brought in contact with (e.g., pressed against) a dispensed polymer resin in order to shape the first polymer layer according to a particular shape or profile. For instance, in the example shown in 1211, the instructions 1204 may enable a mold 1211a may be pressed on top of a first polymer layer 1211b. As shown in the example in 1211, the mold 1211a may be pressed on the first polymer layer 1211b to provide one or more indentations on a surface of the first polymer layer 1211b. In the alternative and as discussed above, in some examples, the dispensed polymer resin may be poured into a cavity or other receiving shape that may be defined by a mold. In some examples, a substrate may then be placed on top of the polymer resin and mold. Also, in some examples, the one or more indentations may be one or more triangular grooves. In addition, in some examples, the first polymer layer 1211b may be located on top of a substrate 1211c.

In this manner, in some examples, the instructions 1204 may produce a first polymer layer according to a particular shape or profile. So, in the example shown in 1212, the instructions 1204 may provide one or more grooves 1212a on the first polymer layer 1212b, wherein the one or more grooves (e.g., produced via use of a mold) may provide one or more surfaces (e.g., facets) on the first polymer layer. In particular, in the example shown in 1212, the first polymer layer 1212b may include the one or more grooves 1212a that may each include a first surface or facet 1212c (e.g., a transverse facet) and a second surface or facet 1212d (e.g., a vertical facet).

In some examples, the instructions 1205 may apply a coating on a surface of a first polymer layer (e.g., as provided via the instructions 1204). In some examples, and as discussed further below, the coating may be applied to produce one or more mirror structures included in a geometric waveguide component. In some examples, the coating may be metallic (e.g., silver), or otherwise a dielectric beamsplitter (e.g., comprised of magnesium fluoride, silicon dioxide, titanium dioxide or others.) may be implemented as well.

In some examples, the instructions 1205 may enable application of a coating in a specified (i.e., deterministic) manner. For example, as shown in 1213, the instructions 1205 may enable coating source 1213a to deposit a coating on top of one or more surfaces of the first polymer layer.

In some examples, the instructions 1205 may apply a coating on one or more facets, such as facets 1213b-c of a first polymer layer. As described above, in some examples, a first polymer layer may include one or more grooves, wherein the one or more grooves may be cut to provide one or more facets (e.g., a transverse facet, a vertical facet, a horizontal facet, etc.) in the first polymer layer.

In some examples, the instructions 1205 may enable application of a coating in a non-uniform manner. More particularly, in some examples, the instructions 1205 may enable applying of the coating according to a reflectivity function to facilitate a homogenous and uniform reflectivity in an optical component (e.g., a geometric waveguide).

In some examples, the instructions 1205 may enable a localized deposition of a coating on a first polymer layer by “transitioning” (i.e., a gradient) from a lesser amount to a greater amount from one portion of the first polymer layer to another. For example, in some examples, the coating source 1213a may deposit less coating on a first end of the first polymer layer and transition to greater amount of coating on the other end of the polymer layer, such that the coating on the (transverse) facet 1213b may be lesser than the coating on the (transverse) facet 1213c.

In some examples, the instructions 1205 may enable application of a coating on a transverse facet, while not applying the coating on a vertical facet (i.e., selective application). In some examples, it may be beneficial to enable light reflectivity via the transverse portion, but not the vertical portion of the groove (as coating the vertical portions may have a negative impact on performance).

In some examples, application of a coating may be enabled via the instructions 1205 via use of a deposition mask. In other examples, the selective application via the instructions 1205 may be enabled via selective emission (e.g., via a spraying gun) of the coating (e.g., in the form of a collimated beam of particles). In still other examples, the selective application via the instructions 1205 may be enabled via inkjet printing or deposition (atomic layer deposition as an example) or via gradient masking methods.

In some examples, the instructions 1206 may enable selective removal of coating from one or more coated surfaces of a first polymer layer. In some examples, the instructions 1206 may enable selective removal of portions of coating from the first polymer layer to produce one or more reflective mirrors comprised in a geometric waveguide. In some examples, it may be beneficial to enable light reflectivity via a first facet of a first polymer layer (e.g., a transverse facet), but not enable light reflectivity via a second facet of the first polymer layer (e.g., a vertical facet). So, in an example where the first facet and the second facet may both be (e.g., uniformly) coated, the instructions 1206 may enable removal of the coating from the second facet but not the first (or vice versa). In some examples, to enable the selective removal, the instructions 1206 may implement diamond turning.

In some examples, the instructions 1207 may enable a second polymer layer to be attached to (e.g., layered on top of) a first polymer layer. In some examples, the second polymer layer may be cast on top of the first polymer layer (i.e., or “overcast”) to produce a composite polymer component including the first polymer layer and the second polymer layer.

In some examples, a material that may comprise a first polymer layer may be same as a material that may comprise a second polymer layer. In other examples, the first polymer layer and the second polymer may be comprised of different materials. Also, in some examples, a second polymer layer cast on top of a first transparent polymer layer may both be transparent, such that the composite polymer component may be optically clear. In some examples and as will be described further below, a composite polymer component as produced via the instructions 1207 may be utilized to produce a geometric waveguide.

In some examples, a second polymer layer may be overcast over a first polymer layer according to one or more (e.g., predetermined) design parameters and/or characteristics. So, in one example, the instructions 1207 may produce the composite polymer component to be produced according to one or more design parameters and/or characteristics (e.g., a shape). For instance, as shown in 1214, the instructions 1207 may enable a second polymer layer may be overcast on top a first polymer layer such that a composite polymer component 1214a may take a rectangular shape. Also, as shown in 1214, the composite polymer component 1214a may include one or more (embedded) mirror structures 1214b.

In some examples, to overcast the second polymer layer over a first polymer layer, the instructions 1207 may implement a mold. In some examples, the (e.g., diamond-turned) mold may be utilized overcast the second polymer layer over the first polymer layer according to one or more design parameters and/or characteristics (e.g., a shape). In some examples, the mold implemented via the instructions 1207 may be comprised of metal and/or plastic. For instance, in the example shown in 1215, a composite polymer component 1215a may be overcast according to a particular shape, and may include one or more mirror structures 1215b.

In some examples, to overcast a second polymer layer over a first polymer layer, the instructions 1207 may enable diamond turning to remove (e.g., cut) some or all of a second polymer layer. In particular, in some examples, where the second polymer layer may be overcast with an excess amount of material. In some examples, the instructions 1207 may utilize diamond turning and/or computerized numerical control (CNC) machining to cut the excess to produce a particular shape (e.g., an ultra-high precision form) for the composite polymer component. In some examples, the instructions 1207 may provide an excess amount of material to counteract results of the fabrication process, such as shrinkage (i.e., deformation), or to otherwise compensate for other aspects associated with an implemented mold. For instance, in the example shown in 1215, the instructions 1207 may enable the composite polymer component 1215a to be overcast and shaped (e.g., cut) according to a particular shape (e.g., via diamond turning), including one or more mirror structures 1215b.

In some examples, the instructions 1208 may enable a release of a composite polymer component from a substrate. For instance, as shown in 1216, a composite polymer component 1216a may be released from a substrate 1216b.

In some examples, the instructions 1209 may provide error correction or error compensation with respect to a composite polymer component. In some examples, in some instances, during casting (as provided via the instructions 1204) or during release (e.g., as provided via the instructions 1208), aspects of the composite polymer component may be altered (e.g., an edge may be bent). In some examples, during casting, one surface of the composite polymer component may no longer be parallel to another surface.

In some examples, the instructions 1209 may provide planarizing, wherein a first surface of a composite polymer component may be polished (i.e., shaped) with respect a second surface of the composite polymer component (e.g., to ensure that the first surface may be parallel to the second surface). In these instances, the instructions 1209 may utilize planarizing to “correct” (e.g., re-shape) one or more aspects the composite polymer component. In some examples, to provide planarizing, the instructions 1209 may enable operation of a lapping plate.

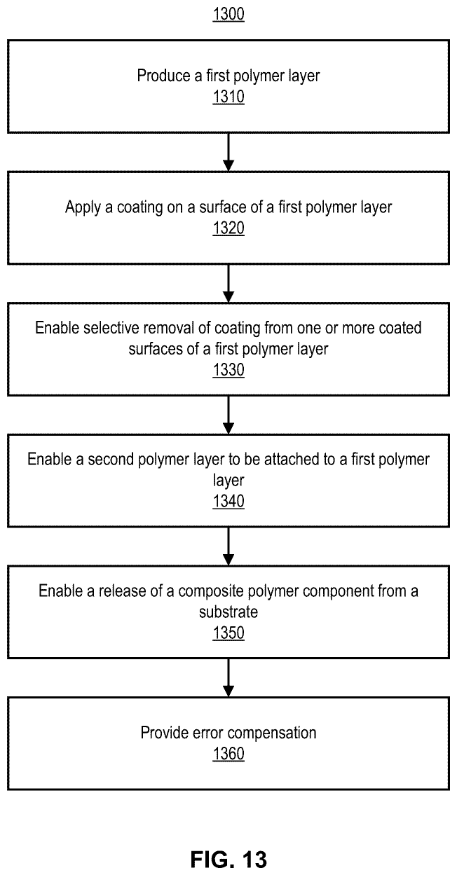

FIG. 13 illustrates a flow diagram of a method for a system, that may be implemented for manufacturing and producing of optical devices having polymeric components, according to an example. The method 1300 is provided by way of example, as there may be a variety of ways to carry out the method described herein. Each block shown in FIG. 13 may further represent one or more processes, methods, or subroutines, and one or more of the blocks may include machine-readable instructions stored on a non-transitory computer-readable medium and executed by a processor or other type of processing circuit to perform one or more operations described herein. Although the method 1300 is primarily described as being performed by system 1200 as shown in FIGS. 12A-12C, the method 1300 may be executed or otherwise performed by other systems, or a combination of systems.

Reference is now made with respect to FIG. 13. At 1310, in some examples, the processor 1201a may cause a first polymer layer to be produced. In some examples, the first polymer layer may serve as a base layer for a composite polymeric component, such as a geometric waveguide to be included in a display device. In some examples, a first polymer layer may be produced via the processor 1201a. In some examples, the processor 1201a may enable a polymer resin (e.g., a transparent monomer liquid resin) to be dispensed (e.g., poured) on to a substrate, and then to be “set” (e.g., cured) into a variety of (e.g., predetermined) shapes and/or profiles. In addition, in some examples, the processor 1201a may cause a mold to be produced that may be utilized to produce a first polymer layer. In particular, in some examples, the processor 1201a may enable the mold to be brought in contact with (e.g., pressed against) a dispensed polymer resin in order to shape the first polymer layer according to a particular shape or profile. In this manner, in some examples, the processor 1201a may produce a first polymer layer according to a particular shape or profile.

At 1320, in some examples, the processor 1201a may cause a coating to be applied on a surface of a first polymer layer. In some examples, the processor 1201a may enable a coating to be applied in a non-uniform and/or deterministic manner. More particularly, in some examples, the processor 1201a may enable the coating to be applied according to a reflectivity function. In some examples, the processor 1201a may implement the reflectivity function to facilitate a homogenous and uniform reflectivity in an optical component (e.g., a geometric waveguide). In some examples, the processor 1201a may enable a localized deposition of a coating on a first polymer layer by “transitioning” (i.e., a gradient) from a lesser amount to a greater amount from one portion of the first polymer layer to another.

In some examples, the processor 1201a may cause a coating to be applied on one or more facets of a first polymer layer. As described above, in some examples, a first polymer layer may include one or more grooves, in which the one or more grooves may be cut to provide one or more facets (e.g., a transverse facet, a vertical facet, a horizontal facet, etc.) in the first polymer layer. In some examples, the processor 1201a may enable application of a coating on a transverse facet, while not applying the coating on a vertical facet. In some examples, this selective application may be enabled via the processor 1201a may be effected via use of a deposition mask. In other examples, the selective application may be effected via a selective emission (e.g., via a spraying gun) of the coating (e.g., in the form of a collimated beam of particles).

At 1330, in some examples, the processor 501a may enable selective removal of coating from one or more coated surfaces of a first polymer layer. In some examples, the processor 1201a may enable selective removal of portions of coating from the first polymer layer to produce one or more reflective mirrors comprised in a geometric waveguide.

At 1340, in some examples, the processor 1201a may enable a second polymer layer to be attached to (e.g., layered on top of) a first polymer layer. In some examples, the second polymer layer may be cast on top of the first polymer layer (i.e., overcast) to produce a composite polymer component including the first polymer layer and the second polymer layer.

In some examples, the processor 1201a may overcast a second polymer layer to a first polymer to produce a composite polymer component. Indeed, in some examples, the second polymer layer may be overcast over the first polymer layer according to one or more (e.g., predetermined) design parameters and/or characteristics.

At 1350, in some examples, the processor 1201a may enable a release of a composite polymer component from a substrate.

At 1360, in some examples, the processor 1201a may provide error compensation (e.g., with respect to a composite polymer component). In some examples, the processor 501a may provide planarizing, wherein a first surface of a composite polymer component may be polished (i.e., shaped) with respect to a second surface of the composite polymer component (e.g., to ensure that the first surface may be parallel to the second surface).

In this description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

According to examples, a display system may include a processor and a memory storing instructions, which when executed by the processor, cause the processor to implement a casting process to produce a first polymer layer, wherein the first polymer layer is supported on a substrate, apply a coating on a surface of the first polymer layer to form one or more mirror structures, and implement an overcasting process to attach a second polymer layer to the first polymer layer to form a composite polymer component.

The instructions, when executed by the processor may further cause the processor to selectively remove a portion of the coating on the surface of the first polymer layer. The instructions, when executed by the processor may further cause the processor to enable a release of the composite polymer component from the substrate. The instructions, when executed by the processor may further cause the processor to provide error compensation with respect to the composite polymer component. The error compensation may include planarizing. The composite polymer component may be implemented in a geometric waveguide. The first polymer layer may include one or more facets upon which the coating is applied. The coating may be applied by transitioning from a lesser amount on a first portion of the first polymer layer to a greater amount on a second portion of the first polymer layer.

According to examples, a method for manufacturing a composite polymer component for a display device may include implementing a casting process to produce a first polymer layer, wherein the first polymer layer is supported on a substrate, applying a coating on a surface of the first polymer layer to form one or more mirror structures, and implementing an overcasting process to attach a second polymer layer to the first polymer layer to form a composite polymer component.

The method may also include selectively removing a portion of the coating on the surface of the first polymer layer and enabling a release of the composite polymer component from the substrate. The method may further include providing error compensation with respect to the composite polymer component. In the method, the composite polymer component may be implemented in a geometric waveguide. In the method, the first polymer layer may include one or more facets upon which the coating is applied. In the method, the applying of the coating may include transitioning from a lesser amount on a first portion of the first polymer layer to a greater amount on a second portion of the first polymer layer.

According to examples, a non-transitory computer-readable storage medium may have executable instructions stored thereon, which when executed may instruct a processor to implement a casting process to produce a first polymer layer, wherein the first polymer layer is supported on a substrate, apply a coating on a surface of the first polymer layer to form one or more mirror structures, and implement an overcasting process to attach a second polymer layer to the first polymer layer to form a composite polymer component.

The executable instructions, when executed may further instruct the processor to selectively remove a portion of the coating on the surface of the first polymer layer. The executable instructions, when executed may further instruct the processor to enable release of the composite polymer component from the substrate. The executable instructions, when executed may further instruct the processor to provide error compensation with respect to the composite polymer component. The applying of the coating may include transitioning from a lesser amount on a first portion of the first polymer layer to a greater amount on a second portion of the first polymer layer.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

Various types of digital communication methods between a plurality of parties have gained significant popularity in recent years. Examples include video and audio conferencing. In some instances, video and audio conferencing may be a convenient alternative to an in-person meeting. For example, since an advent of a global pandemic, many workers (worldwide) have been able to maintain if not increase efficiency through use of these technologies while working remotely.

However, these technologies may also come with their own disadvantages. For example, unwanted sounds from a speaker (e.g., sender) side of an audio or video conference may, in some instances, negatively impact a listener's (e.g., receiver) side experience of the conference.

In some examples, a “noise cancelling” technology (e.g., a software algorithm) may be utilized to minimize or even mute an unwanted noise from captured audio of the conference. Specifically, in some examples, the noise cancelling technology may be configured to, among other things, analyze portion of the captured audio to determine a speaker's voice and other sounds, and may adjust aspects of the captured audio to emphasize the speaker's voice and/or minimize or mute other (captured) sounds that may detrimentally affect a listener's experience.

In some instances, a speaker may have an option to implement a noise canceling technology on a sender-side device (e.g., a laptop computer, a desktop computer, etc.) to minimize impact of unwanted noise. However, in many instances, this may not be sufficient as there may be a number of reasons why the noise cancelling technology may not implement it.

For example, in some instances, noise canceling technology may be processing-intensive and may need to run continuously. In these instances, implementing a noise cancelling technology (e.g., algorithm) may require significant power consumption (e.g., battery life), and may not be feasible for maintaining proper operation of a sender-side device. Also, in some instances, the speaker may not implement (e.g., may simply forget to) implement the noise canceling technology. Furthermore, in some instances, the unwanted noise from the sender-side may be a typical noise, in which case the noise canceling technology may not properly minimize or mute the unwanted noise. In addition, during transmission of captured audio, transmission-side processing (e.g., by a service provider server device) may alter the captured audio to include various unwanted noise as well.

Systems and methods described may provide localized noise reduction for audio transmissions. As used herein, “noise reduction” may include minimization or elimination of audio data that may be undesirable during playback. As used herein, “localized” noise reduction may include any technique that may be applied to audio data in order to minimize undesirable audio data for a listening user. In particular, in some examples, the systems and methods may provide elimination of noise on a receiver side that may optimize a listening experience for a user utilizing a user device receiving the audio data.

In some examples, the systems and methods may provide a one or more interface software elements and associated technical features that may be associated with enabling a receiver user to implement one or more aspects of noise cancelation on a receiver side. That is, by enabling noise cancellation features on the receiver side, the systems and methods may enable noise cancellation that may be localized, and therefore may be more particular to a receiving user's experience.

Moreover, in some examples, and as will be discussed further below, the systems and methods may enable adjustments to noise cancellation features provided. As such, in some examples, a receiving user may be able to modify (e.g., “tune”) noise cancellation features in order to optimize a listening experience. As will be discussed further below, in some examples, the systems and methods may enable the modifications via use of one or more software interface elements.

In some examples, the information associated with localized noise reduction for audio transmissions may be gathered and utilized according to various policies. For example, in particular embodiments, privacy settings may allow users to review and control, via opt in or opt out selections, as appropriate, how their data may be collected, used, stored, shared, or deleted by the systems and methods or by other entities (e.g., other users or third-party systems), and for a particular purpose. The systems and methods may present users with an interface indicating what data is being collected, used, stored, or shared by the systems and methods described (or other entities), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose (as described further below). In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other entities (e.g., other users or third-party systems), or particular processes (e.g., internal research, advertising algorithms, machine-learning algorithms) for a particular purpose. In some examples, the data minimization policies may ensure that only relevant and necessary data may be accessed by such entities or processes for such purposes.

In addition, it should be appreciated that in some examples, the deletion of any data may be subject to data retention policies, which may limit the duration such data that may be user or stored by the systems and methods (or by other entities), or by particular processes (e.g., internal research, advertising algorithms, machine-learning algorithms, etc.) for a particular purpose before being automatically deleted, de-identified, or otherwise made inaccessible. In some examples, the data retention policies may ensure that data may be accessed by such entities or processes only for the duration it is relevant and necessary for such entities or processes for the particular purpose. In particular examples, privacy settings may allow users to review any of their data stored by the systems and methods or other entities (e.g., third-party systems) for any purpose, and delete such data when requested by the user.

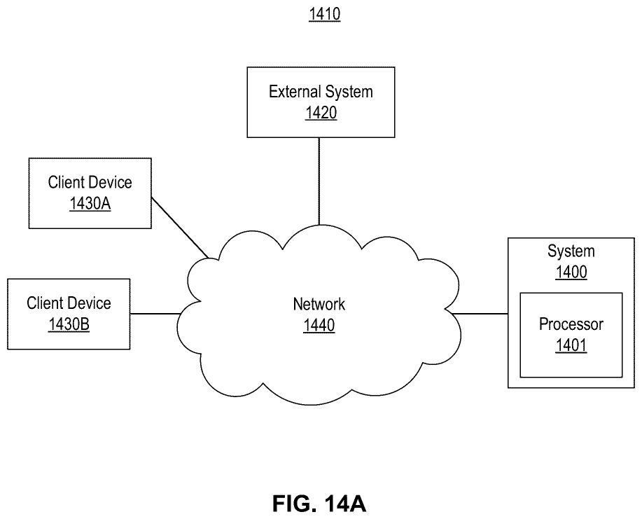

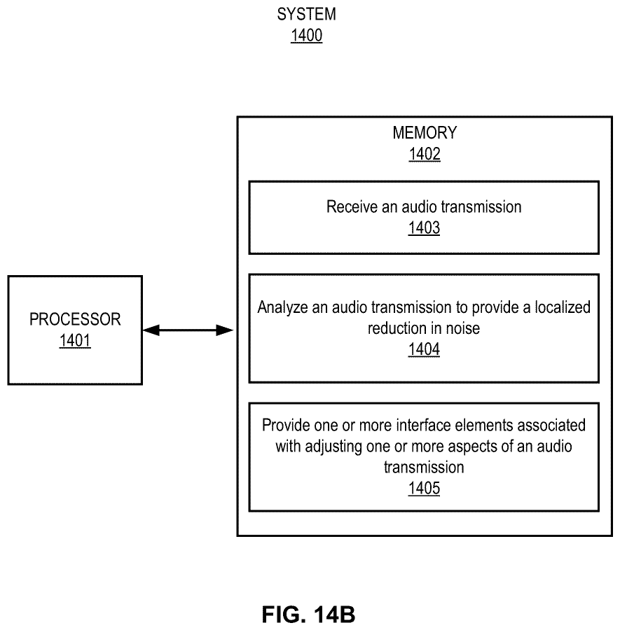

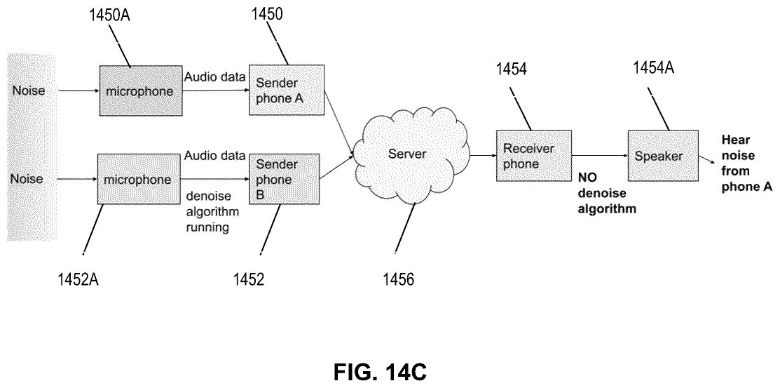

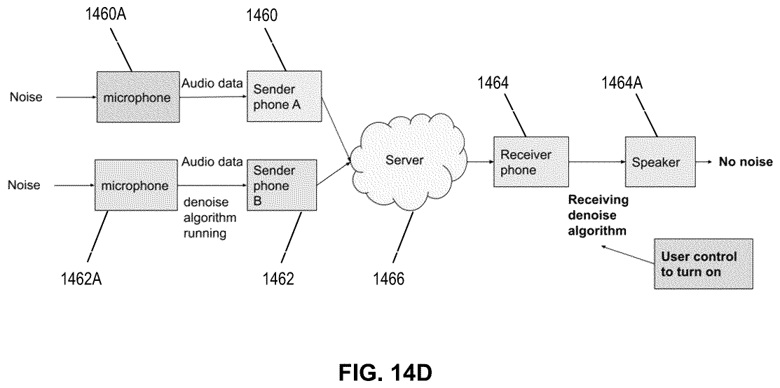

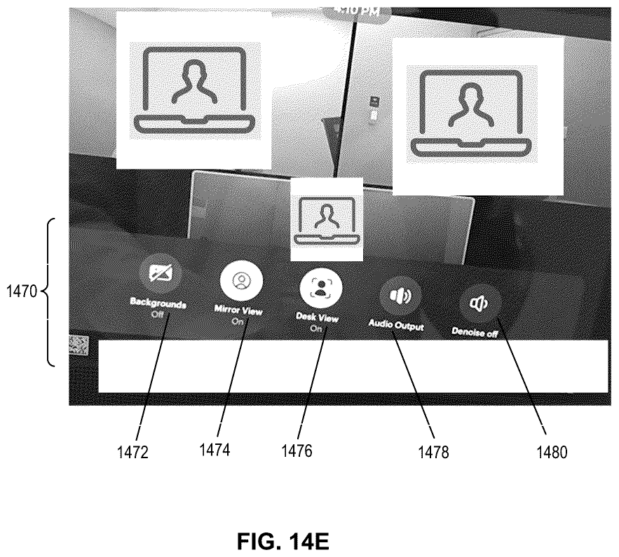

Reference is now made to FIGS. 14A-14B. FIG. 14A illustrates a block diagram of a system environment, including a system, that may be implemented to provide localized noise reduction for audio transmissions, according to an example. FIG. 14B illustrates a block diagram of the system that may be implemented to provide localized noise reduction for audio transmissions, according to an example.

As will be described in the examples below, one or more of system 1400, external system 1420, user devices 1430A-1430B and system environment 1410 shown in FIGS. 14A-14B may be operated by a service provider to provide localized noise reduction for audio transmissions. It should be appreciated that one or more of the system 1400, the external system 1420, the user devices 1430A-1430B and the system environment 1410 depicted in FIGS. 14A-14B may be provided as examples. Thus, one or more of the system 1400, the external system 1420 the user devices 1430A-1430B and the system environment 1410 may or may not include additional features and some of the features described herein may be removed and/or modified without departing from the scopes of the system 1400, the external system 1420, the user devices 1430A-1430B and the system environment 1410 outlined herein. Moreover, in some examples, the system 1400, the external system 1420, and/or the user devices 1430A-1430B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 14A-14B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 1400, the external system 1420, the user devices 1430A-1430B or the system environment 1410.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 1420 may include any number of servers, hosts, systems, and/or databases that store data to be accessed by the system 1400, the user devices 1430A-1430B, and/or other network elements (not shown) in the system environment 1410. In addition, in some examples, the servers, hosts, systems, and/or databases of the external system 1420 may include one or more storage mediums storing any data. In some examples, and as will be discussed further below, the external system 1420 may be utilized to store any information that may relate to generation and delivery of content (e.g., user information, etc.).

In some examples, and as will be described in further detail below, the user devices 1430A-1430B may be utilized to, among other things, provide localized noise reduction in audio transmissions. In some examples, the user devices 1430A-1430B may be electronic or computing devices configured to transmit and/or receive data. In this regard, each of the user devices 1430A-1430B may be any device having computer functionality, such as a television, a radio, a smartphone, a tablet, a laptop, a watch, a desktop, a server, or other computing or entertainment device or appliance. In some examples, the user devices 1430A-1430B may be mobile devices that are communicatively coupled to the network 1440 and enabled to interact with various network elements over the network 1440. In some examples, the user devices 1430A-1430B may execute an application allowing a user of the user devices 1430A-1430B to interact with various network elements on the network 1440. Additionally, the user devices 1430A-1430B may execute a browser or application to enable interaction between the user devices 1430A-1430B and the system 1400 via the network 1440. In some examples, and as will described further below, a client may utilize the user devices 1430A-1430B to access a browser and/or an application interface.

Moreover, in some examples and as will also be discussed further below, the user devices 1430A-1430B may be utilized by a user viewing content (e.g., advertisements) distributed by a service provider, wherein information relating to the user may be stored and transmitted by the user devices 1430A-1430B to other devices, such as the external system 1420.

The system environment 1410 may also include the network 1440. In operation, one or more of the system 1400, the external system 1420 and the user devices 1430A-1430B may communicate with one or more of the other devices via the network 1440. The network 1440 may be a local area network (LAN), a wide area network (WAN), the Internet, a cellular network, a cable network, a satellite network, or other network that facilitates communication between, the system 1400, the external system 1420, the user devices 1430A-1430B and/or any other system, component, or device connected to the network 1440. The network 1440 may further include one, or any number, of the exemplary types of networks mentioned above operating as a stand-alone network or in cooperation with each other. For example, the network 1440 may utilize one or more protocols of one or more clients or servers to which they are communicatively coupled. The network 1440 may facilitate transmission of data according to a transmission protocol of any of the devices and/or systems in the network 1440. Although the network 1440 is depicted as a single network in the system environment 1410 of FIG. 14A, it should be appreciated that, in some examples, the network 1440 may include a plurality of interconnected networks as well.

It should be appreciated that in some examples, and as will be discussed further below, the system 1400 may be configured to utilize artificial intelligence (AI) based techniques and mechanisms to provide localize noise reduction in audio transmissions. Details of the system 1400 and its operation within the system environment 1410 will be described in more detail below.

As shown in FIGS. 14A-14B, the system 1400 may include processor 1401 and the memory 1402. In some examples, the processor 1401 may be configured to execute the machine-readable instructions stored in the memory 1402. It should be appreciated that the processor 1401 may be a semiconductor-based microprocessor, a central processing unit (CPU), an application specific integrated circuit (ASIC), a field-programmable gate array (FPGA), and/or other suitable hardware device.

In some examples, the memory 1402 may have stored thereon machine-readable instructions (which may also be termed computer-readable instructions) that the processor 1401 may execute. The memory 1402 may be an electronic, magnetic, optical, or other physical storage device that contains or stores executable instructions. The memory 1402 may be, for example, random access memory (RAM), an Electrically Erasable Programmable Read-Only Memory (EEPROM), a storage device, an optical disc, or the like. The memory 1402, which may also be referred to as a computer-readable storage medium, may be a non-transitory machine-readable storage medium, where the term “non-transitory” does not encompass transitory propagating signals. It should be appreciated that the memory 1402 depicted in FIGS. 14A-14B may be provided as an example. Thus, the memory 1402 may or may not include additional features, and some of the features described herein may be removed and/or modified without departing from the scope of the memory 1402 outlined herein.

It should be appreciated that, and as described further below, the processing performed via the instructions on the memory 1402 may or may not be performed, in part or in total, with the aid of other information and data, such as information and data provided by the external system 1420 and/or the user devices 1430A-1430B. Moreover, and as described further below, it should be appreciated that the processing performed via the instructions on the memory 1402 may or may not be performed, in part or in total, with the aid of or in addition to processing provided by other devices, including for example, the external system 1420 and/or the user devices 1430A-1430B.

In some examples, the memory 1402 may store instructions, which when executed by the processor 1401, may cause the processor to: receive an audio transmission, analyze a (received) audio transmission to provide a localized reduction in noise, and provide one or more interface elements associated with adjusting one or more aspects of an audio transmission. In some examples, and as discussed further below, the instructions 1403-1405 on the memory 1402 may be executed alone or in combination by the processor 1401 to provide localized noise reduction in audio transmissions. In some examples, the instructions 1403-1405 may be implemented in association with a content platform configured to provide content for users, while in other examples, the instructions 1403-1405 may be implemented as part of a stand-alone application.

In some examples, the instructions 1403 may receive an audio transmission. As discussed above, in some examples, the audio transmission may be associated with an audio communication (e.g., a virtual conference) taking place between a plurality of parties. In some examples, the audio transmission may include audio data that may be utilized for playback. In some examples, the instructions 103 may be configured to utilize audio data associated with the received audio transmission for playback via one or more speakers (e.g., on the system 1400). In other examples, the playback provided via the instructions 1403 may be provided via one or more microphones or headphones as well.

In some examples, the instructions 1404 may analyze a (received) audio transmission to provide a localized reduction in noise. In some examples, the instructions 1404 may be configured to analyze one or more segments of audio data (e.g., audio files) to determine noise to be removed. So, in some examples, the instructions 1404 may analyze a first audio segment that may be free of noise and a second audio segment that may include noise (e.g., barking from a dog in the background). In these examples, the instructions 1404 may “learn” to identify the noise and remove the noise from an audio segment. In some examples, this noise reduction may also be referred to as “noise cancellation” or “de-noise.” By extension, in some examples, an algorithm that may implement the noise reduction may be referred to as a “de-noise algorithm.” In some instances, the de-noise algorithm may also be referred to as a “noise reduction technique.” It may be appreciated that the noise reduction provided via the instructions 1404 may be implemented on a receiver-side, as opposed to a transmitting-side, and therefore may be able to provide localized noise reduction that may be tailored to a listening user's experience.

Reference is now made with respect to FIGS. 14C and 14D. FIG. 14C illustrates an example of a system environment including one or more transmitting devices transmitting an audio signals to a receiving device without noise reduction features, according to an example. In this example, a first user utilizing a first phone 1450 (or “sender phone A”) having a microphone 1450A, a second user utilizing a second phone 1452 (or “sender phone B”) having a microphone 1452A are audio conferencing with a third user utilizing a third phone 1454 having a speaker 1454A over a server 1456. In this example, only the second phone 1452 implements a de-noise algorithm and not the first phone 1450, and therefore the third user utilizing the third phone 1454 (also “receiver phone”) will hear noise originating from the first phone 1450 over the speaker 1454A.

FIG. 14D illustrates an example of a system environment including one or more transmitting devices transmitting an audio signals to a receiving device with noise reduction features, according to an example. In this example, a first user utilizing a first phone 1460 (or “sender phone A”) having a microphone 1460A, a second user utilizing a second phone 1462 (or “sender phone A”) having a microphone 1462A are audio conferencing with a third user utilizing a third phone 1464 having a speaker 1464A over a server 1466. In this example, only the second phone 1462 implements a de-noise algorithm and not the first phone 1460. However, because the third phone 1464 is implementing a localized, receiver-side de-noise algorithm which the third user may activate or deactivate, the third user will not hear the noise originating from the first phone 1460 over the speaker 1464A.

In some examples, to provide the localized reduction in noise, the instructions 1404 may implement one or more noise reduction algorithms (e.g., a “de-noise algorithm”) with respect to an audio transmission. In some examples, this may include analyzing an audio transmission (e.g., as provided via the instructions 1403) to determine a first portion of audio data from the audio transmission to be played during playback and a second portion of the audio data to be minimized during playback. In some examples, minimizing the audio data may include rendering the audio data inaudible during playback. In addition, in some examples, this may include implementing a de-noise algorithm to provide a localized reduction in noise. In some examples, this may include providing the first portion of the audio data to a speaker during the playback and minimizing the second portion of the audio data during the playback (e.g., so that a listening user may only minimally hear or not hear at all).

In some examples, the one or more noise reduction algorithms may be “trained” to differentiate between “signal” (e.g., audio signals that may be associated with or relevant to the audio transmission) and “noise” (e.g., audio signals that may be detrimental or irrelevant to the audio transmission). Also, in some examples, to provide a localized reduction in noise, the instructions 1404 may be configured to implement one or more artificial intelligence (AI) or machine learning (ML) techniques. For instance, these artificial intelligence (AI) based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 1400 may provide other types of machine learning (ML) approaches, such as reinforcement learning, feature learning, anomaly detection, etc. In these examples, one or more de-noise algorithms may be configured to differentiate between signal data associated with the audio transmission and noise data associated with the audio transmission.

In some examples, the instructions 1405 may provide one or more interface elements associated with adjusting one or more aspects of an audio transmission. In particular, in some examples, the one or more interface elements may be implemented to adjust one or more aspects of a de-noise algorithm.

For example, in some instances, the instructions 1405 may provide one or more selectable and/or adjustable buttons that may be accessed (e.g., adjusted, touched, etc.) by a user to control aspects of an audio signal to provide noise reduction in a localized manner. In other examples, the one or more user interface elements may take the form of a dial (e.g., to increase or decrease one or more aspects of the audio transmission) as well. In still other examples, the one or more user interface elements may take the form of a switch that may be turned on or off (e.g., to turn on or turn off application of a de-noise algorithm).

Reference is now made to FIG. 14E. FIG. 14E illustrates one or more interface elements in a user interface configured to provide localized noise reduction features, according to an example. In particular, in this example, FIG. 14E illustrates a plurality of interface elements 1470 associated with a multi-party video conference, wherein a (listening) user may utilize the plurality of interface elements 1470 to conduct the multi-party video conference. In this examples, the plurality of interface elements 1470 includes a background button 1472, a mirror view button 1474, a desk view button 1476, an audio output button 1478, and a de-noise button 1480. In this example, the background button 1472, the mirror view button 1474, and the desk view button 1476 may relate to the visual appearance of the multi-party video conference. Also, in this example, the audio output button 1478 may enable the listening user to adjust a speaker volume for sound associated with the multi-party video conference. In this example, the de-noise button 1480 may enable the listening user to implement a de-noise algorithm that may provide a relevant and/or desirable portion of the audio associated with the multi-party video conference, but may minimize or may mute any irrelevant, undesirable portion that may be associated with the multi-party video conference. In this example, the de-noise button 1480 may take the form of a “on/off” button that may enable (or disable) a de-noise algorithm on a receiving user's side. In other examples, the de-noise button 1480 may take the form of an (e.g., adjustable) dial, which may enable aspects of an associated de-noise algorithm to be adjustably applied.

Accordingly, it may be appreciated that the systems and methods provided herein may provide various benefits. For example, in some instances, by providing localized noise reduction in audio transmission, the systems and methods may provide a superior listening experience for one or more listening users. Moreover, in some examples, by providing the localized noise reduction on the receiver end of the audio transmission, the systems and methods may provide energy efficiency by negating a need for noise reduction features for a transmitting device.

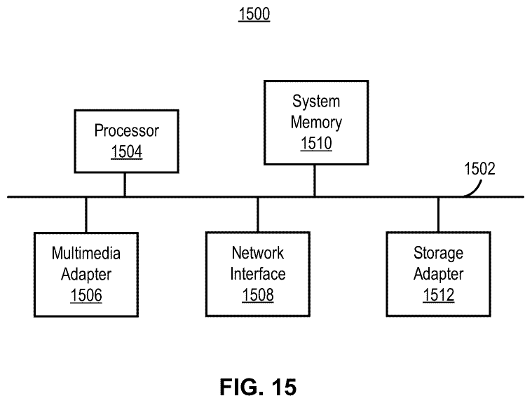

FIG. 15 illustrates a block diagram of a computer system for localized noise reduction for audio transmissions, according to an example. In some examples, the system 1500 may be associated the system 1400 to perform the functions and features described herein. The system 1500 may include, among other things, an interconnect 1502, a processor 1504, a multimedia adapter 1506, a network interface 1508, a system memory 1510, and a storage adapter 1512.

The interconnect 1502 may interconnect various subsystems, elements, and/or components of the external system 1420. As shown, the interconnect 1502 may be an abstraction that may represent any one or more separate physical buses, point-to-point connections, or both, connected by appropriate bridges, adapters, or controllers. In some examples, the interconnect 1502 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 1502 may allow data communication between the processor 1504 and system memory 1510, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1504 may be the central processing unit (CPU) of the computing device and may control overall operation of the computing device. In some examples, the processor 1504 may accomplish this by executing software or firmware stored in system memory 1510 or other data via the storage adapter 1512. The processor 1504 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1506 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1508 may provide the computing device with an ability to communicate with a variety of remote devices over a network (e.g., network 1440 of FIG. 14A) and may include, for example, an Ethernet adapter, a Fibre Channel adapter, and/or other wired- or wireless-enabled adapter. The network interface 1508 may provide a direct or indirect connection from one network element to another, and facilitate communication and between various network elements.

The storage adapter 1512 may connect to a standard computer-readable medium for storage and/or retrieval of information, such as a fixed disk drive (internal or external).

Many other devices, components, elements, or subsystems (not shown) may be connected in a similar manner to the interconnect 1502 or via a network (e.g., network 1440 of FIG. 14A). Conversely, all of the devices shown in FIG. 15 need not be present to practice the present disclosure. The devices and subsystems can be interconnected in different ways from that shown in FIG. 15. The operating system provided on system 1400 may be MS-DOS, MS-WINDOWS, OS/2, OS X, IOS, ANDROID, UNIX, Linux, or another operating system.

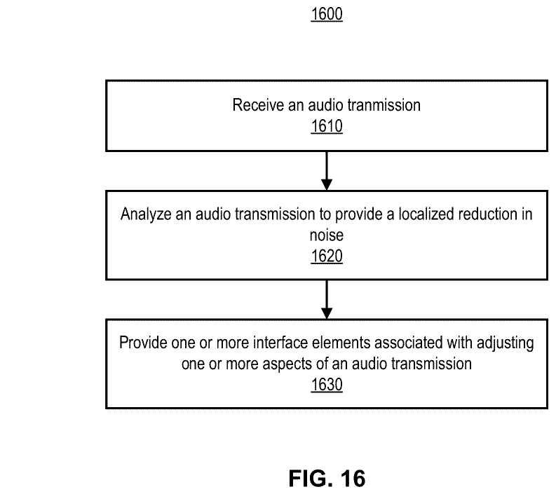

FIG. 16 illustrates a method for localized noise reduction for audio transmissions, according to an example. The method 1600 is provided by way of example, as there may be a variety of ways to carry out the method described herein. Each block shown in FIG. 16 may further represent one or more processes, methods, or subroutines, and one or more of the blocks may include machine-readable instructions stored on a non-transitory computer-readable medium and executed by a processor or other type of processing circuit to perform one or more operations described herein.

Although the method 1600 is primarily described as being performed by system 1400 as shown in FIGS. 14A-14B, the method 1600 may be executed or otherwise performed by other systems, or a combination of systems. It should be appreciated that, in some examples, to provide localized noise reduction for audio transmission, the method 1600 may be configured to incorporate artificial intelligence (AI) or deep learning techniques, as described above. It should also be appreciated that, in some examples, the method 1600 may be implemented in conjunction with a content platform (e.g., a social media platform) to generate and deliver content.

Reference is now made with respect to FIG. 16. At 1610, in some examples, the processor 1401 may receive an audio transmission. As discussed above, in some examples, the audio transmission may be associated with an audio communication (e.g., a virtual conference) taking place between a plurality of parties.

At 1620, in some examples, the processor 1401 may analyze a (received) audio transmission to provide a localized reduction in noise. In some examples, to provide the localized reduction in noise, the processor 1401 may implement one or more noise reduction algorithms (e.g., a “de-noise algorithm”) with respect to an audio transmission. In some examples, to provide a localized reduction in noise, the processor 1401 may be configured to implement one or more artificial intelligence (AI) or machine learning (ML) techniques.

At 1630, in some examples, the processor 1401 may provide one or more interface elements associated with adjusting one or more aspects of an audio transmission. For example, in some instances, the processor 1401 may provide one or more selectable and/or adjustable buttons that may be accessed (e.g., adjusted, touched, etc.) by a user to control aspects of an audio signal to provide noise reduction in a localized manner. In other examples, the one or more user interface elements may take the form of a dial (e.g., to increase or decrease one or more aspects of the audio transmission) as well. In still other examples, the one or more user interface elements may take the form of a switch that may be turned on or off (e.g., to turn on or turn off application of a de-noise algorithm).

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 1400, the external system 1420, and the user devices 1430 that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 1400, the external system 1420, and the user devices 1430, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 1400, the external system 1420, and the user devices 1430, or shared with other systems. Although this disclosure describes using particular privacy settings in a particular manner, this disclosure contemplates using any suitable privacy settings in any suitable manner.

In particular examples, the system 1400, the external system 1420, and the user devices 1430 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 1400, the external system 1420, and the user devices 1430 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 1400, the external system 1420, and the user devices 1430 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 1400, the external system 1420, and the user devices 1430 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 1400, the external system 1420, and the user devices 1430 may access such information in order to provide a particular function or service to the first user, without the system 1400, the external system 1420, and the user devices 1430 having access to that information for any other purposes. Before accessing, storing, or using such objects or information, the system 1400, the external system 1420, and the user devices 1430 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 1400, the external system 1420, and the user devices 1430.

In particular examples, a user may specify whether particular types of objects or information associated with the first user may be accessed, stored, or used by the system 1400, the external system 1420, and the user devices 1430. As an example and not by way of limitation, the first user may specify that images sent by the first user through the system 1400, the external system 1420, and the user devices 1430 may not be stored by the system 1400, the external system 1420, and the user devices 1430. As another example and not by way of limitation, a first user may specify that messages sent from the first user to a particular second user may not be stored by the system 1400, the external system 1420, and the user devices 1430. As yet another example and not by way of limitation, a first user may specify that all objects sent via a particular application may be saved by the system 1400, the external system 1420, and the user devices 1430.

In particular examples, privacy settings may allow a first user to specify whether particular objects or information associated with the first user may be accessed from the system 1400, the external system 1420, and the user devices 1430. The privacy settings may allow the first user to opt in or opt out of having objects or information accessed from a particular device (e.g., the phone book on a user's smart phone), from a particular application (e.g., a messaging app), or from a particular system (e.g., an email server). The system 1400, the external system 1420, and the user devices 1430 may provide default privacy settings with respect to each device, system, or application, and/or the first user may be prompted to specify a particular privacy setting for each context. As an example and not by way of limitation, the first user may utilize a location-services feature of the system 1400, the external system 1420, and the user devices 1430 to provide recommendations for restaurants or other places in proximity to the user. The first user's default privacy settings may specify that the system 1400, the external system 1420, and the user devices 1430 may use location information provided from one of the user devices 1430 of the first user to provide the location-based services, but that the system 1400, the external system 1420, and the user devices 1430 may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 1400, the external system 1420, and the user devices 1430 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 1400, the external system 1420, and the user devices 1430 may use a user's previous activities and calculated moods, emotions, or sentiments to determine a present mood, emotion, or sentiment. A user who wishes to enable this functionality may indicate in their privacy settings that they opt in to the system 1400, the external system 1420, and the user devices 1430 receiving the inputs necessary to determine the mood, emotion, or sentiment. As an example and not by way of limitation, the system 1400, the external system 1420, and the user devices 1430 may determine that a default privacy setting is to not receive any information necessary for determining mood, emotion, or sentiment until there is an express indication from a user that the system 1400, the external system 1420, and the user devices 1430 may do so. By contrast, if a user does not opt in to the system 1400, the external system 1420, and the user devices 1430 receiving these inputs (or affirmatively opts out of the system 1400, the external system 1420, and the user devices 1430 receiving these inputs), the system 1400, the external system 1420, and the user devices 1430 may be prevented from receiving, collecting, logging, or storing these inputs or any information associated with these inputs. In particular examples, the system 1400, the external system 1420, and the user devices 1430 may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 1400, the external system 1420, and the user devices 1430 may use the user's mood, emotion, or sentiment to provide newsfeed items, pages, friends, or advertisements to a user. The user may specify in their privacy settings that the system 1400, the external system 1420, and the user devices 1430 may determine the user's mood, emotion, or sentiment. The user may then be asked to provide additional privacy settings to indicate the purposes for which the user's mood, emotion, or sentiment may be used. The user may indicate that the system 1400, the external system 1420, and the user devices 1430 may use his or her mood, emotion, or sentiment to provide newsfeed content and recommend pages, but not for recommending friends or advertisements. The system 1400, the external system 1420, and the user devices 1430 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 1400, the external system 1420, and the user devices 1430 may be restricted in its access, storage, or use of the objects or information. The system 1400, the external system 1420, and the user devices 1430 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 1400, the external system 1420, and the user devices 1430 may temporarily store the message in a content data store until the second user has viewed or downloaded the message, at which point the system 1400, the external system 1420, and the user devices 1430 may delete the message from the data store. As another example and not by way of limitation, continuing with the prior example, the message may be stored for a specified period of time (e.g., 2 weeks), after which point the system 1400, the external system 1420, and the user devices 1430 may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 1400, the external system 1420, and the user devices 1430 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 1400, the external system 1420, and the user devices 1430. The user's privacy settings may specify that such information may be used only for particular processes, such as authentication, and further specify that such information may not be shared with any external system or used for other processes or applications associated with the system 1400, the external system 1420, and the user devices 1430. As another example and not by way of limitation, the system 1400, the external system 1420, and the user devices 1430 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 1400, the external system 1420, and the user devices 1430. As another example and not by way of limitation, the system 1400, the external system 1420, and the user devices 1430 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 1400, the external system 1420, and the user devices 1430.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 1400, the external system 1420, and the user devices 1430 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 1400, the external system 1420, and the user devices 1430 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 1400, the external system 1420, and the user devices 1430 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 1400, the external system 1420, and the user devices 1430 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 1400, the external system 1420, and the user devices 1430 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 1400, the external system 1420, and the user devices 1430 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 1400, the external system 1420, and the user devices 1430 may send a reminder to the user to confirm his or her privacy settings every six months or after every ten photo posts. In particular examples, privacy settings may also allow users to control access to the objects or information on a per-request basis. As an example and not by way of limitation, the system 1400, the external system 1420, and the user devices 1430 may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

According to examples, a system may include a processor and a memory storing instructions, which when executed by the processor, cause the processor to receive an audio transmission comprising audio data for playback, implement a noise reduction technique to provide a localized reduction in noise. The noise reduction technique may include analyzing the audio transmission to determine a first portion of the audio data to be played during playback and a second portion of the audio data to be minimized during playback, providing the first portion of the audio data to a speaker during the playback, and rendering the second portion of the audio data inaudible during the playback. The instructions may also cause the processor to provide one or more interface elements associated with adjusting one or more aspects of the noise reduction technique.

The audio transmission may be associated with a virtual conference between a plurality of parties. The one or more interface elements may include a button. The one or more interface elements may include a dial.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An apparatus, comprising:
a processor; and
a memory on which is stored machine-readable instructions that when executed by the processor, cause the processor to:
identify an object of interest in at least one first image of an environment captured by a wearable eyewear device during a first time period;
identify the object of interest in at least one second image of the environment captured by a wearable eyewear device during a second time period; and
determine a pattern associated with the object of interest based on the at least one first image of the identified object of interest and the at least one second image.

2. The apparatus of claim 1, wherein the instructions cause the processor to:
apply an artificial intelligence algorithm on the at least one first image and the at least one second image of the object of interest to determine the pattern.

3. The apparatus of claim 2, wherein the instructions cause the processor to:
apply a machine learning algorithm on historical data to create the artificial intelligence algorithm.

4. The apparatus of claim 1, wherein the instructions cause the processor to:
determine an action corresponding to the determined pattern; and
output and/or execute the determined action.

5. The apparatus of claim 4, wherein the instructions cause the processor to:
generate an item to be displayed from the determined action; and
cause the item to be displayed on the wearable eyewear device.

6. The apparatus of claim 1, wherein the instructions cause the processor to:
determine the pattern associated with the object of interest as a rate at which a feature of the object of interest has changed over time based on the images of the identified object of interest during the first time period and the second time period.

7. The apparatus of claim 1, wherein the instructions cause the processor to:
access at least one first sensed condition in the environment detected by a sensor during the first time period;
access at least one second sensed condition in the environment detected by the sensor during the second time period; and
determine the pattern associated with the object of interest based also on the at least one first sensed condition and the at least one second sensed condition.

8. The apparatus of claim 1, wherein the instructions cause the processor to:
access additional images of the environment captured by the wearable eyewear device during additional time periods;
identify the object of interest in the additional images; and
update the pattern associated with the object of interest based on images of the identified object of interest in the additional images.

9. The apparatus of claim 1, wherein the apparatus comprises one of the wearable eyewear device, a computing device, and a server.

10. A method comprising:
accessing, by a processor, at least one first image of an environment captured by a wearable eyewear device during a first time period;
identifying, by the processor, a first feature of an object of interest in the at least one first image;
accessing, by the processor, at least one second image of the environment captured by the wearable eyewear device during a second time period;
identifying, by the processor, a second feature of the object of interest in the at least one second image; and
determining, by the processor, a pattern associated with the object of interest based on the identified first feature and the identified second feature of the object of interest.

11. The method of claim 10, further comprising:
applying an artificial intelligence algorithm on the at least one first image and the at least one second image of the object of interest to determine the pattern.

12. The method of claim 10, further comprising:
determining an action corresponding to the determined pattern; and
outputting and/or executing the determined action.

13. The method of claim 12, further comprising:
generating an item to be displayed from the determined action; and
causing the item to be displayed on the wearable eyewear device.

14. The method of claim 10, further comprising:
determining the pattern associated with the object of interest as a rate at which a feature of the object of interest has changed over time based on the first feature in the at least one first image of the object of interest and the second feature in the at least one second image of the object of interest.

15. The method of claim 10, further comprising:
accessing at least one first sensed condition in the environment detected by a sensor during the first time period;
accessing at least one second sensed condition in the environment detected by the sensor during the second time period; and
determining the pattern associated with the object of interest based also on the at least one first sensed condition and the at least one second sensed condition.

16. The method of claim 10, further comprising:
accessing additional images of the environment captured by the wearable eyewear device during additional time periods;
identifying the object of interest in the additional images; and
updating the pattern associated with the object of interest based on images of the identified object of interest in the additional images.

17. A non-transitory computer-readable medium on which is stored machine-readable instructions that when executed by a processor, cause the processor to:
identify an object of interest in at least one first image of an environment captured by a wearable eyewear device during a first time period;
access at least one first sensed condition in the environment detected by a sensor during the first time period;
identify the object of interest in at least one second image of the environment captured by the wearable eyewear device during a second time period;
access at least one second sensed condition in the environment detected by the sensor during the second time period; and
determine a pattern associated with the object of interest based on the at least one first image of the identified object of interest, the at least one second image of the identified object of interest, the at least one first sensed condition, and the at least one second sensed condition.

18. The non-transitory computer-readable medium of claim 17, wherein the instructions further cause the processor to:
apply an artificial intelligence algorithm on the at least one first image, the at least one second image, the at least one first sensed condition, and the at least on second sensed condition.

19. The non-transitory computer-readable medium of claim 17, wherein the instructions further cause the processor to:
determine an action corresponding to the determined pattern; and
output and/or execute the determined action.

20. The non-transitory computer-readable medium of claim 19, wherein the instructions further cause the processor to:
generate an item to be displayed from the determined action; and
cause the item to be displayed on the wearable eyewear device.
